(19) United States
(12) Patent Application Publication
(10) Pub. No.: US 2024/0342642 A1
(43) Pub. Date: Oct. 17, 2024

(54) CARBON DIOXIDE SORBENT ARTICLE ASSEMBLIES WITH COMPONENTS TO MAINTAIN GAPS BETWEEN SEPARATE SHEETS OF SORBENT ARTICLE

(71) Applicant: W. L. Gore & Associates, Inc., Newark, DE (US)

(72) Inventors: Edward H. Cully, Clarksville, VA (US); Christine M. Scotti, Newark, DE (US); Ryan S. Titone, Flagstaff, AZ (US)

(21) Appl. No.: 18/637,713

(22) Filed: Apr. 17, 2024

Related U.S. Application Data
(60) Provisional application No. 63/634,562, filed on Apr. 16, 2024.
(60) Provisional application No. 63/459,835, filed on Apr. 17, 2023.

(51) Int. Cl. B01D 53/04; B01J 20/28

(52) U.S. Cl. CPC B01D 53/0407; B01J 20/28038; B01J 20/2804; B01J 20/28052; B01D 2253/202; B01D 2257/504; B01D 2258/06

(57) ABSTRACT

Carbon dioxide sorbent article assemblies and methods of manufacturing the same include: separable sheets of sorbent article disposed adjacent to each other to define a gap between adjacent separable sheets, the gap being maintained uniformly between opposing surfaces of adjacent separable sheets to define a passage extending between adjacent separable sheets from an inlet of the separable sheets to an outlet of the separable sheets; and a support framework supporting the separable sheets to maintain the gap, the support framework having a gap-maintaining component extending from the support framework along at least one separable sheet to maintain an initial position of the separable sheet.

### CROSS-REFERENCE TO RELATED APPLICATIONS

This application claims the benefit of U.S. Application No. 63/459,835, filed Apr. 17, 2023, and U.S. Application No. 63/634,562, filed Apr. 16, 2024, which are incorporated herein by reference in their entireties for all purposes.

### FIELD

The present disclosure relates generally to apparatuses, systems, and methods pertaining to sorbent articles. More specifically, the disclosure relates to sorbent articles with gaps maintained therebetween.

### BACKGROUND

Increasing carbon dioxide (CO₂) levels associated with greenhouse emissions are shown to be harmful to the environment. In recent years, the average carbon dioxide level in the atmosphere was increased to the highest level that has been noted in the past 800,000 years. The rate of increase of CO₂ in the atmosphere is also much higher than the rates in previous decades.

In order to limit the impact of climate change, it is not only necessary to reduce CO₂ emissions in the near future to zero but also to achieve negative CO₂ emissions, for example via direct air capture (“DAC”) of CO₂ from the atmosphere. Capturing CO₂ directly from the atmosphere is one of several means of mitigating anthropogenic greenhouse gas emissions and has attractive economic prospects as a non-fossil, location-independent CO₂ source for the commodity market and for the production of synthetic fuels. The specific advantages of CO₂ capture from the atmosphere include: a) DAC can address the emissions of distributed sources (e.g. vehicles . . . land, sea and air), which account for a large portion of the worldwide greenhouse gas emissions and can currently not be captured at the site of emission in an economically feasible way; b) DAC can address legacy emissions and can therefore create truly negative emissions; and c) DAC systems do not need to be attached to the source of emission but may be location independent and can be located at the site of further CO₂ processing or usage.

### SUMMARY

Sorbent article assemblies are described including a plurality of separable sheets of sorbent article structured to adsorb and desorb CO₂ and a plurality of gap-maintaining components to maintain the gaps between the sheets during adsorption and desorption processes, such as during a direct air capture (DAC) event of CO₂, for example.

According to one example (“Example 1”), a carbon dioxide sorbent article assembly includes: separable sheets of sorbent article disposed adjacent to each other to define a gap between adjacent separable sheets, the gap being maintained uniformly between opposing surfaces of adjacent separable sheets to define a passage extending between adjacent separable sheets from an inlet of the separable sheets to an outlet of the separable sheets; and a support framework supporting the separable sheets to maintain the gap, the support framework having a gap-maintaining component extending from the support framework along at least one separable sheet to maintain an initial position of the separable sheet.

According to another example (“Example 2”), a carbon dioxide sorbent article assembly includes: separable sheets of sorbent article disposed adjacent to each other to define a gap between adjacent separable sheets, the gap being maintained uniformly between opposing surfaces of adjacent separable sheets to define a passage extending between adjacent separable sheets from an inlet of the separable sheets to an outlet of the separable sheets; and a support framework supporting the separable sheets to maintain the gap, the support framework having gap-maintaining components extending from the support framework through an internal portion of each of the separable sheets to maintain an initial position of each of the separable sheets.

According to another example (“Example 3”), a carbon dioxide sorbent article assembly includes: separable sheets of sorbent article disposed adjacent to each other to define a gap between adjacent separable sheets, the gap being maintained uniformly between opposing surfaces of adjacent separable sheets to define a passage extending between adjacent separable sheets from an inlet of the separable sheets to an outlet of the separable sheets; and a support framework supporting the separable sheets to maintain the gap, the support framework having gap-maintaining components extending from the support framework through adjacent separable sheets to maintain an initial position of each of the separable sheets, the gap-maintaining components having internal portions passing through the adjacent separable sheets and gap portions disposed between the adjacent separable sheets.

According to another example (“Example 4”), a carbon dioxide sorbent article assembly includes: separable sheets of sorbent article disposed adjacent to each other to define a gap between adjacent separable sheets, the gap being maintained uniformly between opposing surfaces of adjacent separable sheets to define a passage extending between adjacent separable sheets from an inlet of the separable sheets to an outlet of the separable sheets; and a support framework supporting the separable sheets to maintain the gap, each of the separable sheets having a gap-maintaining component extending from the separate sheet to rest on the support framework and to maintain an initial position of the separable sheet hanging from the support framework.

According to another example (“Example 5”) further to any one of Examples 1-4, the gap-maintaining component or the separable sheets are under tension to maintain the initial position.

According to another example (“Example 6”) further to Example 2, the gap-maintaining component comprises a plurality of substantially planar structural members attached to the support framework in order to maintain the separable sheets in a taut configuration.

According to another example (“Example 7”) further to Example 6, each of the structural members includes a first surface and a second surface, and at least one of the first or second surface comprises one of the separable sheets attached thereto.

According to another example (“Example 8”) further to Example 7, the separable sheets are attached to both the first surface and the second surface of the structural member such that the structural member is disposed between two of the separable sheets.

According to another example (“Example 9”) further to Example 8, the structural members are at least one of: films, filaments, metallic or polymeric sheets, metallic, polymeric meshes, or fabrics.

According to another example (“Example 10”) further to Example 1, each of the separable sheets includes a shortened-length portion and the gap-maintaining component is an elastomer component disposed on the separable sheets at the shortened-length portion.

According to another example (“Example 11”) further to Example 10, the shortened-length portion is formed via corrugation or crumpling of a portion of the separable sheet.

According to another example (“Example 12”) further to Example 10 or 11, the shortened-length portion of the each of the separable sheets assumes one of a shortened configuration and an elongated configuration.

According to another example (“Example 13”) further to Example 12, the separable sheets change between the shortened configuration and the elongated configuration in response to swelling or shrinkage of a material forming the separable sheets.

According to another example (“Example 14”) further to Example 1, the gap-maintaining component comprises a plurality of elongated members attached to the support framework in a taut configuration such that the elongated members provide support for the separable sheets.

According to another example (“Example 15”) further to Example 14, the elongated members form a crisscross pattern such that each of the separable sheets are disposed between two neighboring elongated members.

According to another example (“Example 16”) further to Example 14 or 15, each of the elongated members comprises at least one of: a wire, a fiber, or a filament.

According to another example (“Example 17”) further to Example 3, the gap-maintaining component comprises a plurality of fibers threaded through the separable sheets in a predetermined threading pattern.

According to another example (“Example 18”) further to Example 17, ends of the separable sheets are in contact with or coupled to an inner surface of the support framework.

According to another example (“Example 19”) further to Example 17 or 18, the assembly further includes an adhesive or fastener attachable to the separable sheets to the support framework.

According to another example (“Example 20”) further to Example 19, the adhesive or fastener is attached to a portion of the separable sheets.

According to another example (“Example 21”) further to Example 17, the fibers comprise a first set of fibers and a second set of fibers, the first set of fibers is threaded in a first threading pattern, and the second set of fibers is threaded in a second threading pattern symmetrical to the first threading pattern.

According to another example (“Example 22”) further to Example 2, the gap-maintaining component is an elongated member with a plurality of enlarged members attached thereto, such that the elongated member punctures through each of the separable sheets, and each of the enlarged members is attached to one of the separable sheets.

According to another example (“Example 23”) further to Example 22, the enlarged members are self-expanding plugs.

According to another example (“Example 24”) further to Example 22 or 23, the assembly further includes a plurality of sealing members that seal openings formed by the elongated member puncturing through the separable sheets.

According to another example (“Example 25”) further to Example 2, the gap-maintaining component is an elongated member, and the separable sheets have a plurality of self-sealing locations to maintain sheet integrity where the separable sheets engage the elongated member.

According to another example (“Example 26”) further to Example 25, the self-sealing locations include a plurality of polymeric components disposed on a surface of the separable sheets to attach the elongated member to the separable sheets.

According to another example (“Example 27”) further to Example 2, the gap-maintaining component is an elongated member having a plurality of enlarged portions and puncturing through each of the separable sheets, and the carbon dioxide sorbent article assembly further includes a plurality of sealing members attached to the separable sheets and seals openings formed by the elongated member puncturing through the separable sheets.

According to another example (“Example 28”) further to Example 23, the sealing members are formed as a plurality of hardened adhesive dots extending through the separable sheets, the hardened adhesive dots have a portion extending outwardly from a surface of the separable sheet.

According to another example (“Example 29”) further to Example 28, one or more of the hardened adhesive dots includes a through-hole therein to allow passage of the elongated member therethrough and prevent passage of the plurality of enlarged portions therethrough.

According to another example (“Example 30”) further to Example 2, the gap-maintaining component is a filament with a plurality of stitched portions, such that each of the stitched portions attaches the filament to one of the separable sheets.

According to another example (“Example 31”) further to Example 2, the gap-maintaining component comprises a plurality of solid frames, and each of the separable sheets is supported by one of the solid frames.

According to another example (“Example 32”) further to Example 31, the separable sheets are formed in tubular configuration and disposed around the solid frames.

According to another example (“Example 33”) further to Example 31, the predetermined distance is defined by a distance between two centerlines of a neighboring pair of solid frames in the solid frames.

According to another example (“Example 34”) further to Example 33, the each of the separable sheets defines an internal volume when supported by the one of the solid frames, the internal volume assumes a restricted configuration during the adsorption process and an expanded configuration during the desorption process.

According to another example (“Example 35”) further to Example 34, the each of the separable sheets includes one or more openings coupled with the internal volume and facilitates passage of air or steam therethrough.

According to another example (“Example 36”) further to Example 4, the separable sheets are suspended vertically from the support framework.

According to another example (“Example 37”) further to Example 36, the gap-maintaining component includes a rigid member having a thickness and tabs extending therefrom that rest on and are supported by a frame component of the support framework.

According to another example (“Example 38”) further to Example 37, each of the separable sheets includes a weighted portion applying additional gravitational force on the separable sheet.

According to one example (“Example 39”), a method of manufacturing a carbon dioxide sorbent article assembly includes: aligning a plurality of separable sheets of sorbent articles adjacent to each other, the separable sheets comprising a first set of the separable sheets and a second set of the separable sheets; threading a first set of fibers through the separable sheets; axially displacing the first set of the separable sheets with respect to the second set of the separable sheets; applying an outward tensioning force on ends of the fibers to form a gap volume with a predetermined distance between each neighboring pair of separable sheets in the separable sheets; and attaching the ends of the fibers to a support framework to maintain the gaps formed between the separable sheets during adsorption and desorption processes.

According to another example (“Example 40”) further to Example 39, the method further includes: disposing the separable sheets inside the support framework such that ends of the separable sheets are in contact with or coupled to an inner surface of the support framework while maintaining the outward tensioning force on the ends of the fibers.

According to another example (“Example 41”) further to Example 40, the method further includes: disposing an adhesive or fastener between at least a portion of the separable sheets and the inner surface of the support framework to immobilize the ends of the portion of the separable sheets with respect to the inner surface of the support framework.

According to another example (“Example 42”) further to Example 39, the method further includes: threading a second set of fibers through the separable sheets; and axially displacing the second set of separable sheets with respect to the first set of separable sheets. The outward tensioning force is applied to both the first and second sets of fibers, and the ends of both the first and second sets of fibers are attached to the support framework to maintain the gaps.

According to another example (“Example 43”) further to Example 42, the first and second sets of fibers are threaded through the separable sheets so as to be substantially symmetrical with respect to each other.

According to one example (“Example 44”), a method for removing gaseous carbon dioxide from an atmosphere includes: receiving information about a dispersion of a first quantity of gaseous carbon dioxide into the atmosphere at a first location; initiating a method of separating a second quantity of gaseous carbon dioxide from the atmosphere at a second location, the second quantity being at least a portion of the first quantity, wherein the method of separating includes the use of the sorbent article assembly of any one of Examples 1-38; and initiating a reporting of data regarding the second quantity.

According to one example (“Example 45”), a method for removing gaseous carbon dioxide from an atmosphere includes: receiving information about a first quantity of gaseous carbon dioxide; separating a second quantity of gaseous carbon dioxide from the atmosphere, the second quantity being at least a portion of the first quantity, wherein the method of separating includes the use of the sorbent article assembly of any one of Examples 1-38; and reporting data regarding the second quantity.

According to one example (“Example 46”), a method for removing gaseous carbon dioxide from an atmosphere includes: transmitting information about a dispersion of a first quantity of gaseous carbon dioxide into the atmosphere at a first location; requesting initiation of a method of separating a second quantity of gaseous carbon dioxide from the atmosphere at a second location, the second quantity being at least a portion of the first quantity, wherein the method of separating includes the use of the sorbent article assembly of any one of Examples 1-38; and receiving a reporting of data regarding the second quantity.

According to one example (“Example 47”), a method for removing gaseous carbon dioxide from an atmosphere includes: receiving, from a computing device, a first electronic communication comprising information about a dispersion of a first quantity of gaseous carbon dioxide into the atmosphere at a first location; initiating a separating, by a carbon capture device, of a second quantity of gaseous carbon dioxide from the atmosphere at a second location, the second quantity being at least a portion of the first quantity, wherein the carbon capture device is the sorbent article assembly of any one of Examples 1-38; and initiating a reporting of data associated with the carbon capture device regarding the second quantity, wherein the data forms part of a second electronic communication.

According to another example (“Example 48”) further to Example 47, the second electronic communication is configured to be transmitted to the computing device.

According to another example (“Example 49”) further to Example 47 or 48, the second electronic communication is configured to be transmitted to an additional computing device.

According to one example (“Example 50”), a method for removing gaseous carbon dioxide from an atmosphere includes: receiving, from a computing device, a first electronic communication comprising information about a first quantity of gaseous carbon dioxide; separating, by a carbon capture device, a second quantity of gaseous carbon dioxide from the atmosphere, the second quantity being at least a portion of the first quantity, wherein the carbon capture device is the sorbent article assembly of any one of Examples 1-38; and reporting, as a second electronic communication, data associated with the carbon capture device regarding the second quantity.

According to another example (“Example 51”) further to Example 50, the second electronic communication is configured to be transmitted to the computing device.

According to another example (“Example 52”) further to Example 50 or 51, the second electronic communication is configured to be transmitted to an additional computing device.

According to one example (“Example 53”), a method for removing gaseous carbon dioxide from an atmosphere includes: transmitting, to a computing device, a first electronic communication comprising information about a dispersion of a first quantity of gaseous carbon dioxide into the atmosphere at a first location; requesting a separating, by a carbon capture device, of a second quantity of gaseous carbon dioxide from the atmosphere at a second location, the second quantity being at least a portion of the first quantity, wherein the carbon capture device is the sorbent article assembly of any one of Examples 1-38; and receiving a second electronic communication comprising an indication of a reporting of data associated with the carbon capture device regarding the second quantity.

According to another example (“Example 54”) further to Example 53, the second electronic communication is received from the computing device.

According to another example (“Example 55”) further to Example 53 or 54, the second electronic communication is received in response to transmitting the first electronic communication.

According to one example (“Example 56”), a method for removing gaseous carbon dioxide from an atmosphere includes: receiving information about a dispersion of a first quantity of gaseous carbon dioxide into the atmosphere at a first location; initiating a separating of a second quantity of gaseous carbon dioxide from the atmosphere at a second location, the second quantity being at least a portion of the first quantity, wherein the separating includes the use of the sorbent article assembly of any one of Examples 1-38; and initiating a reporting of data regarding the second quantity.

According to one example (“Example 57”), a method for removing gaseous carbon dioxide from an atmosphere includes: transmitting information about a dispersion of a first quantity of gaseous carbon dioxide into the atmosphere at a first location; requesting a separating a second quantity of gaseous carbon dioxide from the atmosphere at a second location, the second quantity being at least a portion of the first quantity, wherein the separating includes the use of the sorbent article assembly of any one of Examples 1-38; and receiving a reporting of data regarding the second quantity.

The foregoing Examples are just that, and should not be read to limit or otherwise narrow the scope of any of the inventive concepts otherwise provided by the instant disclosure. While multiple examples are disclosed, still other embodiments will become apparent to those skilled in the art from the following detailed description, which shows and describes illustrative examples. Accordingly, the drawings and detailed description are to be regarded as illustrative in nature rather than restrictive in nature.

### BRIEF DESCRIPTION OF THE DRAWINGS

The accompanying drawings are included to provide a further understanding of the disclosure and are incorporated in and constitute a part of this specification, illustrate embodiments, and together with the description serve to explain the principles of the disclosure.

FIG. 1 is a schematic diagram of a sorbent article assembly according to embodiments disclosed herein;

FIG. 2 is a schematic diagram of a sorbent article assembly according to an embodiment disclosed herein;

FIG. 3A is a schematic diagram of a sorbent article assembly in a state of shortened length according to an embodiment disclosed herein;

FIG. 3B is a schematic diagram of the sorbent article assembly of FIG. 3A in a state of extended length according to an embodiment disclosed herein;

FIG. 4A is an isometric view of a structural framework for containing or supporting sorbent articles according to an embodiment disclosed herein;

FIG. 4B is a side view of a structural framework for containing or supporting sorbent articles according to an embodiment disclosed herein;

FIGS. 5A through 5H are schematic diagrams of processes of forming a sorbent article assembly according to embodiments disclosed herein;

FIGS. 6A and 6B are schematic diagrams of a sorbent article assembly according to embodiments disclosed herein;

FIG. 7A is a schematic diagram of a sorbent article assembly according to an embodiment disclosed herein;

FIG. 7B is a cross-sectional diagram of another sorbent article assembly according to an embodiment disclosed herein;

FIG. 8 is a schematic diagram of a sorbent article assembly according to an embodiment disclosed herein;

FIG. 9A is a schematic diagram of a structural framework for supporting sorbent article according to an embodiment disclosed herein;

FIG. 9B is an angled view of a sorbent article system including a plurality of the structural frameworks as shown in FIG. 9A and sorbent articles according to an embodiment disclosed herein;

FIG. 9C is an expanded view of a portion of the sorbent article system shown in FIG. 9B;

FIG. 9D is a schematic diagram of the sorbent article assembly during adsorption according to an embodiment disclosed herein;

FIG. 9E is a schematic diagram of the sorbent article assembly during desorption according to an embodiment disclosed herein;

FIG. 10A is an angled view of a sheet of sorbent article and a framework assembly according to an embodiment disclosed herein;

FIG. 10B is an expanded view of a sheet of sorbent article and a framework assembly shown in FIG. 10A according to an embodiment disclosed herein;

FIG. 10C is a partial view of the sheets of sorbent article to be implemented with the framework assembly of FIGS. 10A and 10B according to an embodiment disclosed herein;

FIG. 11 (prior-art) is an angled view of a sorbent article assembly using dome-shaped solid dots disposed on a surface of the plates to maintain gaps between plates of sorbent polymer composite (SPC) as known in the art.

### DETAILED DESCRIPTION

### Definitions and Terminology

This disclosure is not meant to be read in a restrictive manner. For example, the terminology used in the application should be read broadly in the context of the meaning those in the field would attribute such terminology.

With respect to terminology of inexactitude, the terms “about” and “approximately” may be used, interchangeably, to refer to a measurement that includes the stated measurement and that also includes any measurements that are reasonably close to the stated measurement. Measurements that are reasonably close to the stated measurement deviate from the stated measurement by a reasonably small amount as understood and readily ascertained by individuals having ordinary skill in the relevant art. Such deviations may be attributable to measurement error, differences in measurement and/or manufacturing equipment calibration, human error in reading and/or setting measurements, minor adjustments made to optimize performance and/or structural parameters in view of differences in measurements associated with other components, particular implementation scenarios, imprecise adjustment and/or manipulation of objects by a person or machine, and/or the like, for example. In the event it is determined that individuals having ordinary skill in the relevant art would not readily ascertain values for such reasonably small differences, the terms “about” and “approximately” can be understood to mean plus or minus 10% of the stated value.

### Description of Various Embodiments

Persons skilled in the art will readily appreciate that various aspects of the present disclosure can be realized by any number of methods and apparatuses configured to perform the intended functions. It should also be noted that the accompanying drawing figures referred to herein are not necessarily drawn to scale, but may be exaggerated to illustrate various aspects of the present disclosure, and in that regard, the drawing figures should not be construed as limiting.

The present disclosure relates to sorbent article assemblies as well as systems incorporating the same and methods of forming such assemblies. While the sorbent article is described below for use in capture of CO₂ from an air feed stream, for example, it may be used in other adsorbent methods and applications. These methods include, but are not limited to, adsorption of substances from various inputs, including other gas feed streams (e.g., combustion exhaust) and liquid feed streams (e.g., ocean water). The adsorbed substance is not limited to CO₂. Other adsorbed substances may include, but are not limited to, other gas molecules (e.g., N₂, CH₄, and CO), liquid molecules, and solutes. In certain embodiments, the input may be dilute, containing on the order of parts per million (ppm) of the desired substance.

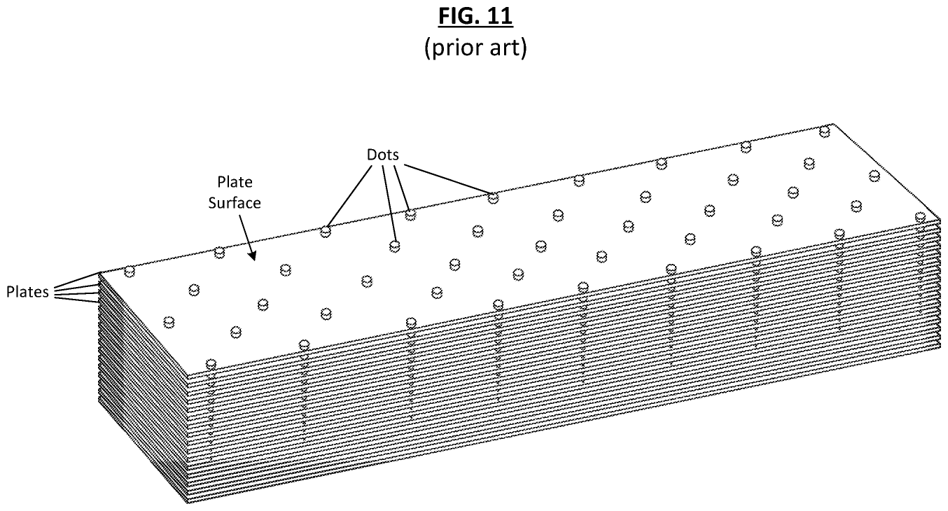

FIG. 11 shows a sorbent article assembly as known in the art. The sorbent article assembly includes a plurality of fibrous plates (labeled as “Plates” in the drawing) or mats made of a sorbent polymer material, where the plates are flat and can be positioned in a parallel configuration with respect to one another. The plates are separated via gaps which are maintained by a plurality of solid dots (labeled as “Dots” in the drawing) which may be disposed or attached onto a surface of the plates and have a protrusion extending from a surface of the plate (labeled as “Plate Surface”) in order to define the distance of the gap between neighboring plates. Each of the gaps defines a gap volume, or a space defined by the gap between two neighboring pieces of sorbent polymer, in which the solid dots occupy. The solid dots as known in the art are sufficiently rigid so as to provide structural support to maintain the gaps and the gap volumes and are attached to the surface via adhesive or glue. As such, the solid dots are not functional as a sorbent material. In fact, the solid dots partially cover the surface of the plates to prevent or inhibit the covered portion of the plate surface from effectively facilitating CO₂ adsorption. In some examples, the solid dots may additionally or alternatively provide undesired resistance to the CO₂ adsorption sites on the plates. Furthermore, in some cases, the solid dots may create some degree of flow disturbance which may negatively affect the ability of CO₂ to diffuse into the material of the plates.

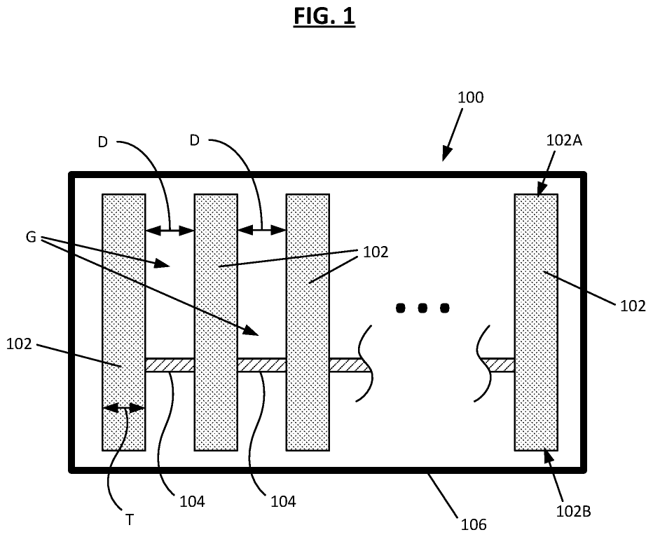

FIG. 1 illustrates a direct air capture (DAC) system or carbon dioxide sorbent assembly 100 which includes a plurality of separable sheets 102 of sorbent article or sorbent element, which may also be referred to as a sorbent polymer composite (SPC), with a first end 102A and a second end 102B opposite from the first end 102A. The first end 102A may be referred to as a “top end” and the second end 102B may be referred to as a “bottom end” if the sheets 102 are disposed substantially vertically with respect to a support framework 106. The sheets 102 may be formed so as to be substantially flat when laid on a flat surface. The assembly 100 includes at least one gap-maintaining component 104 which is associated with the sheets 102. The assembly 100 may be used to capture CO₂ in any suitable environment, such as capturing CO₂ from the surrounding air, for example.

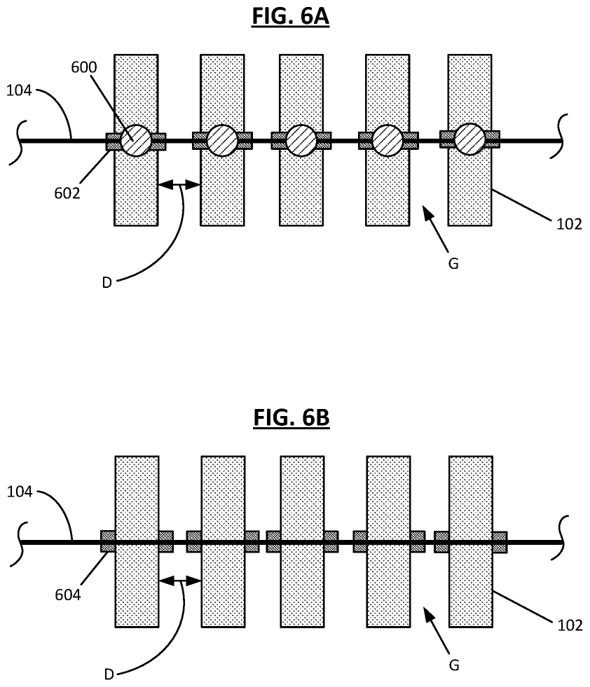

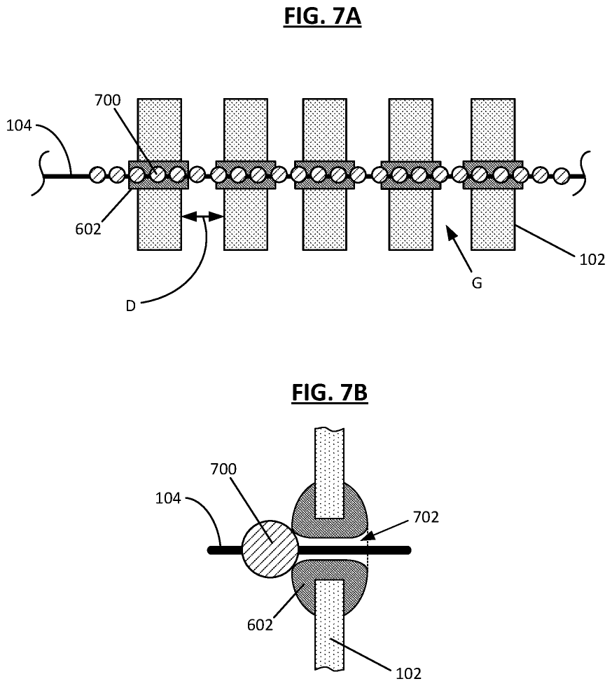

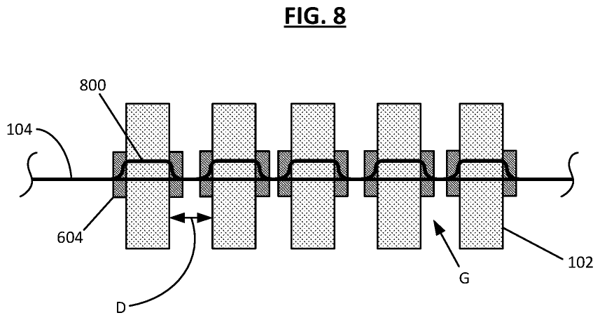

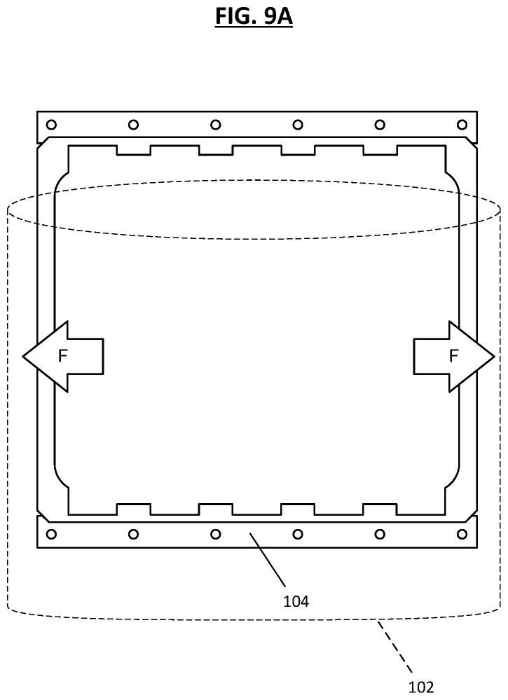

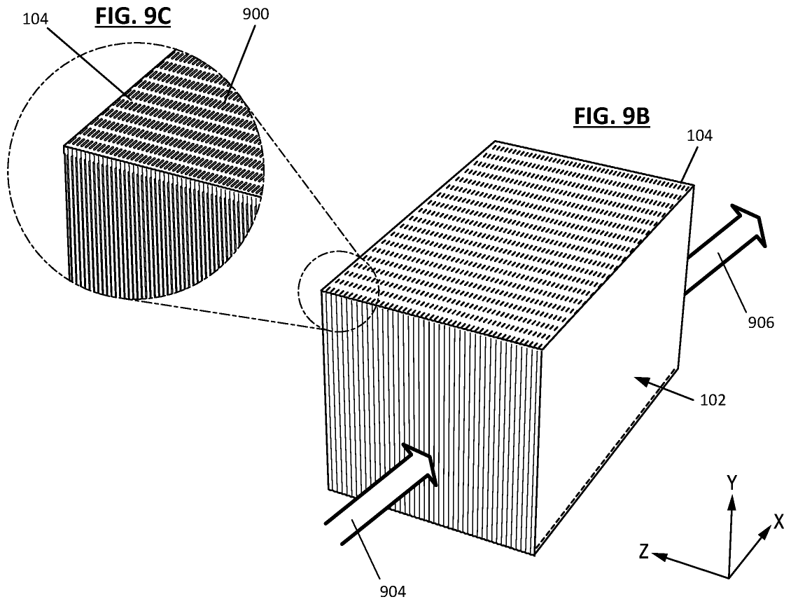

The assembly 100 also includes the support framework 106 which provides structural support for the assembly 100. The sheets 102 are disposed within the framework 106 and define a gap or gap volume “G” with a predetermined distance “D” between two neighboring sheets 102. The gap-maintaining component 104 is supported by the framework 106 and maintains the predetermined distance D between the sheets 102 during adsorption and desorption processes of a DAC process. The gap-maintaining component may also occupy no greater than about 30%, no greater than about 25%, no greater than about 20%, no greater than about 10%, no greater than about 5%, or no greater than about 1%, but at least 0.1%, of the gap volume G, or any other suitable range or value therebetween as appropriate. As further disclosed herein, separable sheets 102 of sorbent article may be disposed adjacent to each other to define the gap G between adjacent separable sheets 102, where the gap G is maintained uniformly between opposing surfaces of adjacent separable sheets 102 to define a passage extending between adjacent separable sheets 102 from an inlet of the separable sheets 102 to an outlet of the separable sheets 102. An inlet may be defined by the location at which an inflow 904 of gas enters the gaps between the sheets 102, and an outlet may be defined by the location at which an outflow 906 of gas exits the gaps, as shown in FIG. 9B, for example, during the operation of the assembly 100. In some examples, the separable sheet(s) 102 and/or the gap-maintaining component(s) 104 may be under tension to maintain the initial position of the separable sheet(s) 102 and the gaps G therebetween.

The sorbent article sheets, or elements, are structured to adsorb and desorb (or capture and release) molecules such as CO₂, such as via DAC. The sorbent article sheets may be sufficiently soft and flexible so as to facilitate movement thereof during adsorption and desorption (or capture and release) of molecules. The sorbent article sheets may be made using one or more of the following materials: expanded polytetrafluoroethylene (ePTFE), polytetrafluoroethylene (PTFE), expanded polyethylene (ePE), another suitable porous polymer, or other material having an appropriate structure. In some examples, the sorbent article sheets are made of flexible porous polymer. It will be appreciated that non-woven materials such as nanospun, meltblown, spunbond, and porous cast films could be among the various other suitable porous polymers.

The sorbent material used in forming the sheets may be a substrate having a surface configured to hold the desired substance (e.g., CO₂) from the input on the surface via adsorption. The sorbent material may vary based on which substances are targeted for adsorption. In various embodiments, the sorbent material includes a CO₂ -adsorbing material which may include, but is not limited to, an ion exchange resin (e.g., a strongly basic anion exchange resin such as Dowex™ Marathon™, a resin available from Dow Chemical Company), zeolite, activated carbon, alumina, metal-organic frameworks, polyethyleneimine (PEI), or another suitable carbon dioxide adsorbing material, such as desiccant, carbon molecular sieve, carbon adsorbent, graphite, activated alumina, molecular sieve, aluminophosphate, silicoaluminophosphate, zeolite adsorbent, ion exchanged zeolite, hydrophilic zeolite, hydrophobic zeolite, modified zeolite, natural zeolites, faujasite, clinoptilolite, mordenite, metal-exchanged silico-aluminophosphate, uni-polar resin, bi-polar resin, aromatic cross-linked polystyrenic matrix, brominated aromatic matrix, methacrylic ester copolymer, graphitic adsorbent, carbon fiber, carbon nanotube, nano-materials, metal salt adsorbent, perchlorate, oxalate, alkaline earth metal particle, ETS, CTS, metal oxide, chemisorbent, amine, organo-metallic reactant, hydrotalcite, silicalite, zeolitic imidazolate framework and metal organic framework (MOF) adsorbent compounds, and combinations thereof.

The sorbent material used in forming the sorbent article sheets may be present as a coating, a filling, entrained particles, and/or in another suitable form. In some examples, the sorbent article sheets may be formed by coating any suitable sheet of material with a sorbent material such that the sorbent material forms a substantially continuous coating on the surface of the sheets or otherwise integrated with the sheets of material. Suitable sorbent coatings may be formed using any one or more of the appropriate sorbent materials as described above

The gap-maintaining components 104 may achieve maintaining the distance D using any of the means and configurations as disclosed herein. The gap-maintaining components 104 may also be associated with the sheets 102 in different ways, including but not limiting to attaching, coupling, supporting, or being integrated in the sheets 102, as further disclosed herein.

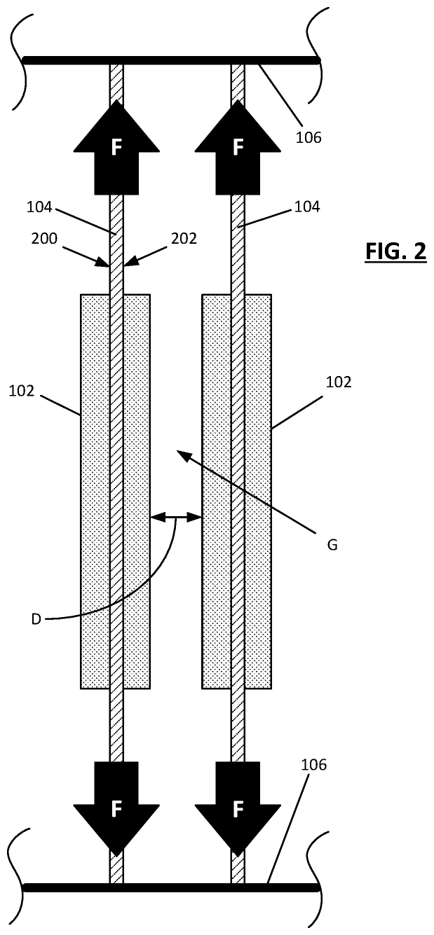

In FIG. 2, the support framework 106 supporting the separable sheets 102 to maintain the gap G may include gap-maintaining components 104 extending from the support framework 106 through an internal portion of each separable sheet 102 to maintain an initial position of the separable sheet 102. For example, the gap-maintaining components 104 are substantially planar structural members which are configured to be attached to the framework 106 in order to maintain the sheets 102 in a taut configuration, as shown by the thick arrows indicating force “F” being applied in the directions as illustrated. For example, the gap-maintaining component 104 may be film(s), structure(s) made of filaments, metallic sheet(s), polymeric sheet(s), metallic mesh structure(s), polymeric mesh structure(s), fabric(s), or any other suitable configuration which can be substantially thin and flexible but can retain the taut configuration while being supported by the framework 106.

In some examples, the gap-maintaining component 104 includes a first surface 200 and a second surface 202. At least one of the first surface 200 or second surface 202 may have one of the sheets 102 attached thereto. That is, in some examples, a sheet 102 may be attached to the first surface 200 while another sheet 102 may be attached to the second surface 202, thereby sandwiching the gap-maintaining component 104 from both sides such that the gap-maintaining component 104 is disposed between two sheets 102. In some examples, there may be only one sheet 102 attached to one surface, either the first surface 200 or the second surface 202, but not both. In some examples, multiple sheets 102 may be attached on the first surface 200 and/or the second surface 202 such that it is not limited to just one sheet 102 being attached to one surface. The multiple sheets 102 may overlap one another when attached to the respective surface. In some examples, the thickness of the gap-maintaining component 104 may be from about 25 μm to about 50 μm, from about 50 μm to about 0.1 mm, from about 0.1 mm to about 0.2 mm, from about 0.2 mm to about 0.5 mm, or any other suitable value or range therebetween or combinations of ranges. Beneficially, such configuration enables the fixation of the sheets 102 while reducing the number or the amount of material used in “spacers” to maintain the gap distance D therebetween, as well as allowing the non-functional thermal mass to be placed in the center of the sheets 102, which does not need to be heated, thus creating further thermal mass reduction.

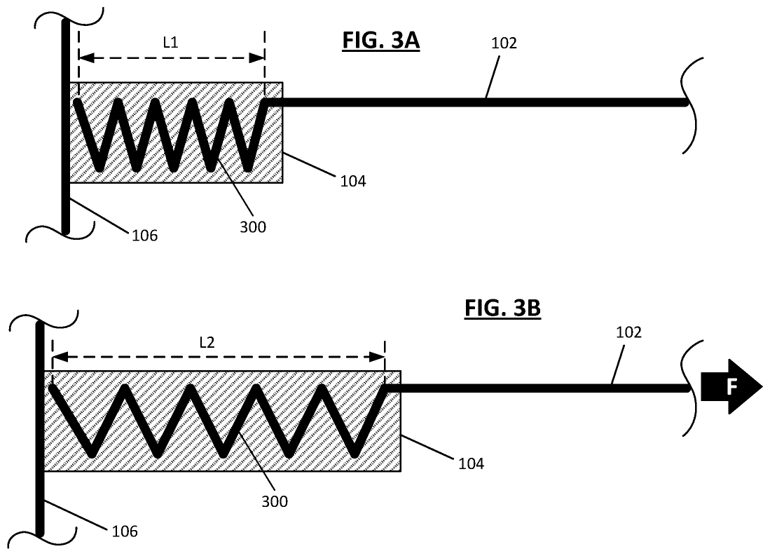

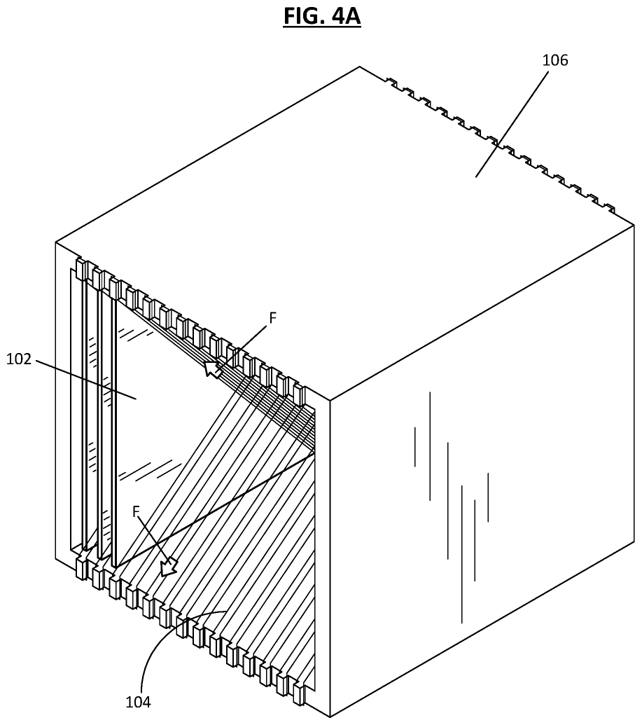

In FIGS. 3A and 3B, the support framework 106 supporting the separable sheets 102 to maintain the gap G may include a gap-maintaining component(s) 104 extending from the support framework 106 along at least one separable sheet 102 to maintain an initial position of the separable sheet 102. For example, the gap-maintaining component 104 is an elastomer component disposed on the sheet. The elastomer component may be any suitable elastomeric polymer including but not limited to thermoset polymers and thermoplastic polymers. The elastomer component may be applied on the surface of the sheet 102 as a coating and/or integrated within the material of the sheet 102 such as via filling an interconnected network of the material forming the sheet 102. For example, in FIG. 3A, the elastomer or gap-maintaining component 104 is applied on the sheet 102 at a portion 300 of the sheet 102 whose length is shortened.

The shortened-length portion 300 may be formed by corrugating or crumpling the appropriate portion of the sheet 102 to have a shortened length, and then applying the gap-maintaining component 104 to the corrugated or crumpled portion to retain the state of corrugation or crumpling in such portion, thereby forming the shortened-length portion 300 whose default length may be a first length “L1” as shown in FIG. 3A but may be uniaxially or biaxially elongated, stretched, or extended to a greater length such as a second length “L2” as shown in FIG. 3B when a force F is applied in the direction shown by the thick arrow.

In some examples, the corrugation or crumpling in the shortened-length portion 300 may be formed using any suitable method for forming a structured or compacted material as known in the art, such as those disclosed in U.S. Pat. No. 11,097,527 (W. L. Gore & Associates GmbH), for example. For example, a rotatable elastic carrier belt may be fixed to two rotating elements that induce and release transverse stretch to the silicone substrate along a circular motion. The sheet 102 may be applied via pressure roll on the stretched elastic carrier belt. The sheet 102 moves on the stretched elastic carrier belt and a structured or compacted sheet 102 is formed during relaxation of the elastic carrier belt. Subsequently, a support material may be preheated with an infrared heater, for example, and applied via pressure roll on the structured or compacted sheet 102 at a predetermined location to form a composite comprising a structured or compacted sheet 102 and the support material. The support material may be the elastomer or gap-maintaining component 104 which, when applied to the predetermined location, forms the shortened-length portion 300. Other methods as disclosed in the aforementioned U.S. Pat. No. 11,097,527 may be implemented to form the corrugation or crumpling in the shortened-length portion 300, as suitable.

As such, the application of the elastomer component allows the sheet 102, or more specifically the portion 300 of the sheet 102, to assume one of a shortened configuration (that is, L1) and an elongated configuration (that is, L2) without substantially or permanently deforming or breaking the sheet 102, thereby beneficially taking up slack and allowing shrinkage between cycles of adsorption and desorption processes. In some examples, there may be additional intermediate configurations spanning the lengths between L1 and L2, such that the sheet 102 may assume any intermediate configuration, i.e., any configuration(s) in which the portion 300 assumes a length that is longer than L1 and shorter than L2 without reaching the minimal or maximal length that can be assumed by the portion 300. In some examples, the elastomer component may be used as adhesive to attach one end (e.g., 102A or 102B) of the sheet 102 to the framework 106 such that the force F is applied with respect to the framework 106.

In some examples, the switching from one configuration to another, that is, from L1 to L2 and from L2 to L1 of the portion 300, may be in response to the swelling or shrinkage of a material forming the sheets 102. In some examples, the swelling and shrinkage may be dependent on the state of water content or humidity of the environment or within the system or assembly 100, or lack thereof. That is, in some examples, dryness of the environment may cause the shrinkage, and wetness may cause the swelling. In some examples, the swelling and shrinkage may take place during the adsorption and desorption processes of the DAC event, and while the length of the portion 300 may change, the gap distance D between neighboring sheets 102 or neighboring portion 300 of the sheets 102 remains substantially the same.

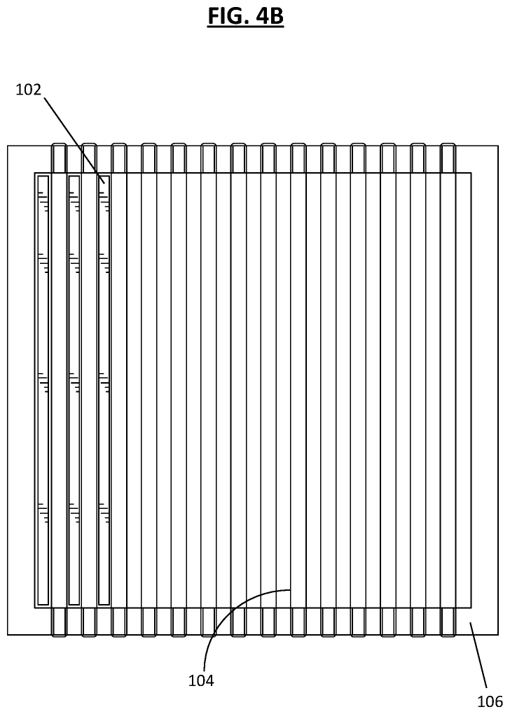

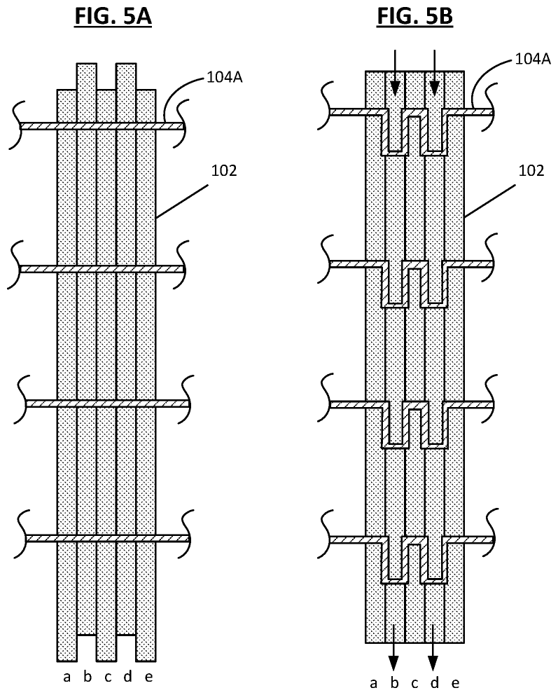

In FIGS. 4A and 4B, the support framework 106 supporting the separable sheets 102 to maintain the gap G may include a gap-maintaining component(s) 104 extending from the support framework 106 along at least one separable sheet 102 to maintain an initial position of the separable sheet 102. For example, the gap-maintaining components 104 are a plurality of elongated members attached to the framework 106 in a taut configuration such that the elongated members provide support for the sheets 102 which are to be inserted into the space between neighboring elongated members. That is, the gap-maintaining components 104 may be kept taut to maintain the spaces in response to the framework 106 applying a constant force F in the directions as shown by the thick arrows. With the spaces retained, the gap distance D also maintains constant such that the sheets 102 are kept in their predetermined positions within the framework 106.

In some examples, the gap-maintaining components 104 may form a pattern such as a crisscross pattern as shown in the figures such that each of the sheets 102 are disposed between two neighboring gap-maintaining components 104, for example between a first gap-maintaining component extending in one direction and a second gap-maintaining component extending in another direction separate from the first gap-maintaining component. In some examples, the gap-maintaining components 104 may be selected from one or more of: wires, fibers, or filaments or any suitable material and size, as appropriate. For example, wires may be preferable for a larger structure using thicker sheets 102, and filaments may be preferable for a smaller structure using thinner sheets 102, as determined by the usage of the carbon dioxide sorbent assembly 100 or DAC system implementing the same. In some examples, there may be only a single gap-maintaining component 104 which extends back and forth in the crisscross configuration between the top portion and the bottom portion of the framework 106, such that a single wire or filament may be used to support all the sheets 102. In some examples, the pattern may be any other suitable pattern including but not limited to honeycomb, lattice, sinusoidal, polygonal, etc. In some examples, there may be no distinct pattern but rather the gap-maintaining components 104 are disposed and arranged in a non-pattern or at random. Such configurations beneficially provide a low-mass means of providing structural support for the sheets 102 as well as having a low-to zero-surface area impact.

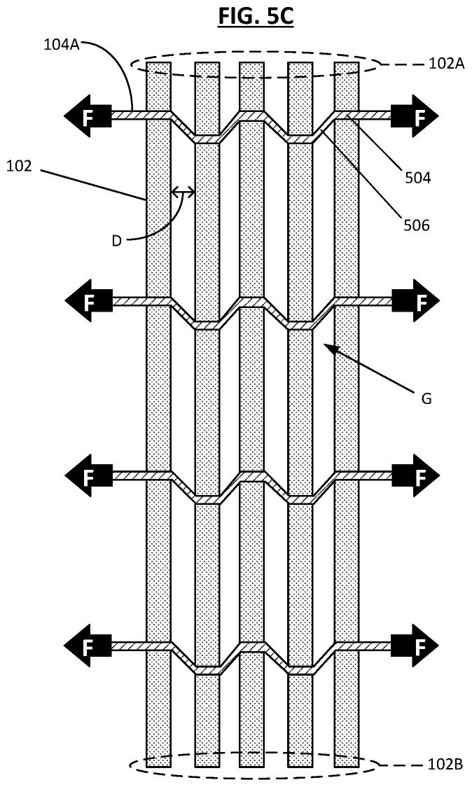

FIGS. 5A through 5H illustrate embodiments of forming the sorbent article assembly 100 in which the gap-maintaining components 104 include fibers or elongated fibrous components which are threaded through the sheets 102 in a predetermined threading pattern. In one embodiment, there may be fibers 104A being threaded or weaved through the sheets 102 to provide support, as shown in FIGS. 5A through 5E. In another embodiment, there may be additional fibers 104B being threaded or weaved through the sheets 102 to provide additional support, as shown in FIGS. 5F through 5H.

In FIG. 5A, the sheets 102 are prepared such that they are arranged in a stacked orientation or side-by-side adjacent configuration. Although there are only five (5) sheets 102 being shown (labeled “a,” “b,” “c,” “d,” and “e” in FIG. 5A), it is to be understood that any suitable number of sheets 102 may be utilized. In the figure, a plurality of fibers 104A are threaded or weaved through all the sheets 102 in multiple locations. In some examples, the threading locations may be equidistant from each other.

In FIG. 5B, a portion of the sheets 102 are moved or displaced in an axial direction show by the arrows relative to the remaining sheets 102 to create a W-shaped threading pattern in the threading. For example, this may be achieved by holding “a,” “c,” and “e” of the sheets 102 in place while moving or sliding “b” and “d” of the sheets 102 downward with respect to “a,” “c,” and “e” of the sheets 102. The same result can be achieved by holding “b” and “d” of the sheets 102 in place and moving or sliding upward “a,” “c,” and “e” of the sheets 102 with respect to “b” and “d” of the sheets 102.

In FIG. 5C, outward tensioning forces F are applied in the directions indicted by the thick arrows in order to pull apart the sheets 102 such that they are no longer in contact with each other and form gap volume G with gap distance D as shown. In FIG. 5D, ends 102A and 102B of the sheets 102 are in contact with an inner surface 500 of the support framework 106 in order to maintain the gap distance D. In such embodiments, the sheets 102 may have sufficient rigidity such that the force against the inner surface 500 would be sufficient to support the sheets 102. In some examples, the framework 106 may also have individual slots (not shown) to receive the rigid sheets 102, such that the sheets 102 may be coupled to the framework 106 without the use of any adhesive or fastener.

In some examples, the ends 102A and 102B of the sheets 102 may be coupled to the framework 106 in order to maintain the sheets 102 in the taut configuration. The coupling may be achieved using fasteners or adhesive 502 as shown in FIG. 5E, for example, or any other suitable means as appropriate. In some examples, the fasteners or adhesive 502 may be applied to attach some of the ends 102A and 102B (such as at the top ends 102A of “a,” “c,” and “e” of the sheets 102 and at the bottom ends 102B of “b” and “d” of the sheets 102) to the framework 106, such that every other sheet 102 is attached to and immobilized with respect to the framework 106 as shown.

In FIG. 5F, which directly follows the configuration shown in FIG. 5B, after the W-shaped pattern is achieved by the first fibers 104A, the second fibers 104B may be threaded or weaved through the sheets 102 as shown, where the bottom portion of the W-shaped pattern of the first fibers 104A are proximate to the second fibers 104B.

In FIG. 5G, “a,” “c,” and “e” of the sheets 102 are moved or displaced in an axial direction indicated by the arrows relative to “b” and “d” of the sheets 102, which remain in place. Alternatively, “a,” “c,” and “e” of the sheets 102 may be held in place while “b” and “d” of the sheets 102 may be moved or displaced in an axial direction opposite from the arrows shown in the figure, to achieve the same result. As a result, the fibers 104B may form an M-shaped pattern that is substantially symmetrical to the W-shaped pattern of the fibers 104A. Therefore, the fibers 104A may be threaded in a first threading pattern, and the fibers 104B may be threaded in a second threading pattern that is substantially symmetrical to the first threading pattern.

In FIG. 5H, outward tensioning forces F are applied in the directions indicted by the thick arrows in order to pull apart the sheets 102 such that they are no longer in contact with each other and form gap volume G with gap distance D as shown. In some examples, the sheets 102 may be disposed in the framework 106 such that there is a gap or space between the ends 102A and 102B of the sheets 102 and the inner surface 500 of the framework 106, thus not being in direct contact with the framework 106. Such configurations beneficially allow the tension in the threaded fibers to seek equalization and to align the sheets 102 while separating them, providing a low-mass means of providing structural support for the sheets 102.

In summary, the assembly 100 as disclosed in FIGS. 5A through 5H may be formed or manufactured using the following process: aligning the sheets 102 adjacent to each other such that the sheets 102 include a first set of sheets (e.g., “a,” “c,” and “e” in FIGS. 5A through 5H) and a second set of sheets (e.g., “b” and “d” in FIGS. 5A through 5H); threading the fibers 104A through the sheets 102; axially displacing the first set of sheets 102 with respect to the second set of sheets 102 as shown in FIG. 5B; applying an outward tensioning force F on the ends of the fibers 104A as shown in FIG. 5C to form a gap volume G with a predetermined gap distance D between each neighboring pair of sheets 102; and attaching the ends of the fibers 104A to the framework 106 to maintain the gap distance D formed between the sheets 102 during adsorption and desorption processes.

In some examples, the process also includes disposing the sheets 102 inside the framework 106 such that ends 102A and 102B of the separable sheets are in contact with or coupled to the inner surface 500 of the framework 106 while maintaining the outward tensioning force F on the ends of the fibers 104A, as shown in FIG. 5D. In some examples, the process also includes disposing the adhesive or fastener 502 between some of the sheets 102 and the inner surface 500 of the framework 106 to immobilize the end 102A or 102B of some of the sheets 102 with respect to the inner surface 500 of the framework 106.

In some examples, the process alternatively includes threading the second set of fibers 104B through the sheets 102 as shown in FIG. 5F, and axially displacing the second set of separable sheets 102 with respect to the first set of separable sheets 102 as shown in FIG. 5G, such that the outward tensioning force F is applied to both the first and second sets of fibers 104A and 104B, and the ends of both the first and second sets of fibers 104A and 104B are attached to the framework 106 to maintain the gap distance D as shown in FIG. 5H. In some examples, the first and second sets of fibers 104A and 104B are threaded through the sheets 102 so as to be substantially symmetrical with respect to each other.

As shown in FIGS. 5C and 5H, the support framework 106 supporting the separable sheets 102 to maintain the gap G may include gap-maintaining components 104 extending from the support framework 106 through adjacent separable sheets 102 to maintain an initial position of the separable sheet 102. The gap-maintaining components 104 may also have internal portions 504 (or 504A and 504B in FIG. 5H) passing through the adjacent separable sheets 102 and gap portions 506 (or 506A and 506B in FIG. 5H) disposed between the adjacent separable sheets 102.

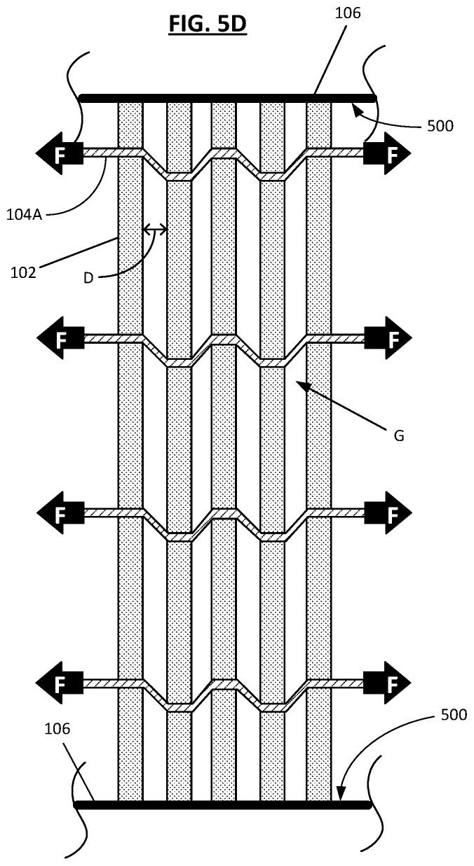

In FIGS. 6A-B, 7A-B, 8, and 9A-E, the support framework 106 supporting the separable sheets 102 to maintain the gap G may include gap-maintaining components 104 extending from the support framework 106 through an internal portion of each separable sheet 102 to maintain an initial position of the separable sheet 102. Examples of such configurations are disclosed herein. In FIG. 6A, the gap-maintaining component 104 is an elongated member with a plurality of enlarged members 600 attached thereto, such that the elongated member or the gap-maintaining component 104 is configured to puncture through each of the sheets 102, and each of the enlarged members 600 is attached to one of the sheets 102. In some examples, the enlarged members or the gap-maintaining components 104 may be self-expanding plugs. In some examples, such plugs may be made of foam or any suitable self-expanding polymer such as self-expanding elastomer. In some examples, the gap-maintaining component 104 may include a plurality of sealing members 602 configured to seal openings formed by the elongated member or gap-maintaining component 104 puncturing through the sheets 102. For example, the sealing members 602 may be any suitable polymer including but not limited to elastomeric polymers including but not limited to thermoset polymers and thermoplastic polymers.

In FIG. 6B, the gap-maintaining component 104 is an elongated member, and the sheets 102 have a plurality of self-sealing locations 604 to maintain sheet integrity where the sheets 102 engage the elongated member or gap-maintaining component 104. The self-sealing locations 604 may be determined by or include polymeric components disposed on a surface of the sheets 102 to attach the elongated member or gap-maintaining component 104 to the sheets 102. The polymeric components may be disposed on one surface or both surfaces of the sheets 102. The polymeric components may be made of the same or similar material as the sealing members 602, and the polymeric components and the sealing members 602 may be disposed on a surface of the sheets 102 or extend through the thickness of the sheets 102, as suitable.

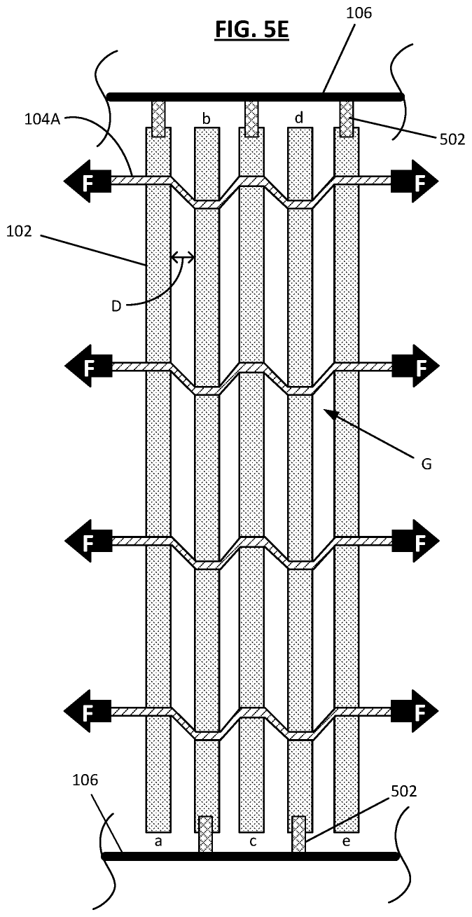

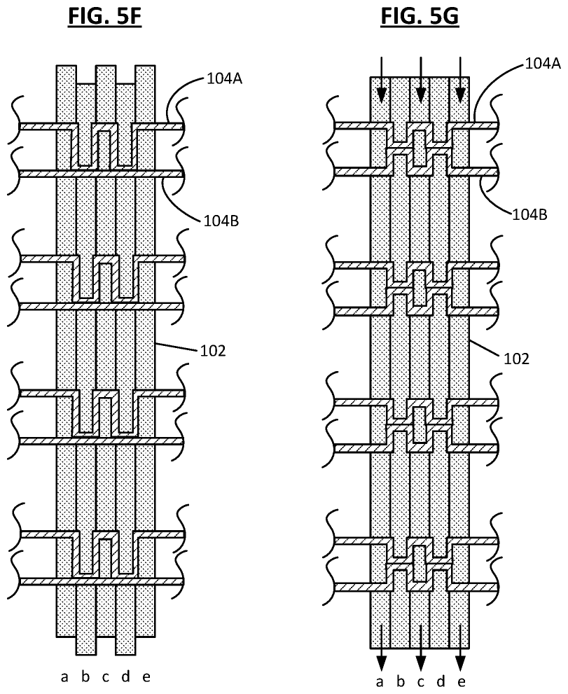

In FIG. 7, the gap-maintaining component 104 is an elongated member having a plurality of beads or enlarged portions 700, or alternatively a beaded chain. The elongated member or gap-maintaining component 104 punctures through each of the sheets 102, the plurality of sealing members 602 attached to the sheets 102 assist in sealing the openings formed by the elongated member or gap-maintaining component 104 puncturing through the sheets 102. In some examples, the beads 700 may be protrusions, raised portions, or enlarged portions of the elongated member that are integral to the elongated member (e.g., the elongated member being a flexible rope-like component which form a plurality of knots, in which case the knots may be considered such protrusions).

FIG. 7B shows an example in which the gap-maintaining component 104 includes the sealing members 602 that are formed as a plurality of dots 602 made of an adhesive polymer disposed through the sheets 102 such that a portion of the adhesive dots 602 protrudes outwardly from the sheets 102. The sheets 102 include apertures, openings, or through-holes puncturing through the sheet 102 such that the adhesive that forms the adhesive dot 602 is capable of penetrating through the sheet 102 before hardening to become the adhesive dot 602. The hardening of the adhesive may be facilitated by drying or curing using any suitable means as disclosed herein. The dots 602 may be formed by applying the polymer (in a malleable or viscous state) on a surface until the polymer penetrates through the hole to reach the other surface. After drying or cooling (or applying any other suitable curing methods), the polymer hardens or solidifies to form the dots 602, which have a cross-sectional shape that resembles the letter “H”, where the entirety of each dot 602 is made of a single continuous material.

The adhesive dots 602 penetrating through the sheet 102 also includes an aperture or through-hole 702 that provides a passage way for the gap-maintaining component 104 to pass therethrough, and the gap-maintaining component 104 may have one or more stoppers (such as the beads or enlarged portions 700, or alternatively, the enlarged members 600) with a cross-sectional distance that is greater than the diameter or cross-sectional distance of the through-hole 702, thereby preventing the stopper 700 from completely passing through the through-hole 702. Beneficially, the adhesive dots 602 provide added weight for the sheets 102 to be maintained in a substantially straight configuration, as well as to reduce the likelihood of the neighboring sheets 102 directly contacting each other. Because the adhesive dots 602 extend through the entire thickness of the sheets 102, the dots 602 are also less likely to fall off the sheets 102 as compared to examples in which the adhesive is only applied to a surface of the sheets 102, which increases the likelihood of the adhesive falling off the surface of the sheets 102, for example due to the hydrophobic nature of the material of the sheets 102.

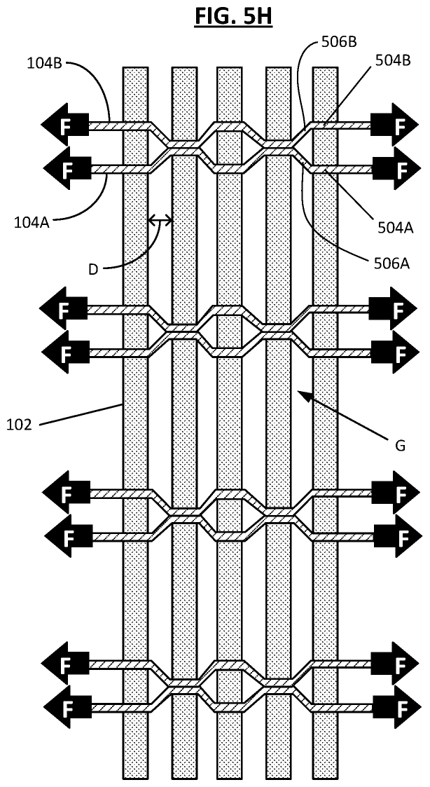

In FIG. 8, the gap-maintaining component 104 is a filament with a plurality of stitched portions 800, such that each of the stitched portions attaches the filament or gap-maintaining component 104 to one of the sheets 102. In some examples, the self-sealing locations 604 may be determined by or include the polymeric components disposed on a surface of the sheets 102 to attach the stitched portion 800 of the fiber or gap-maintaining component 104 to the sheets 102. In FIGS. 7 and 8, the polymeric components or the sealing members 602 may be disposed on the surface of the sheets 102 or extend through the thickness of the sheets 102, as suitable. In some examples, the elongate members may be compliable material such as suture which may not provide structural support by itself, while the additional components such as the enlarged members 600, sealing members 602, self-sealing locations 604, beads or protrusions 700, and/or stitched portions 800 as disclosed herein may control the locations along the elongate members at which the sheets 102 may be disposed upon installation. As such, the configurations of FIGS. 6A, 6B, 7, and 8 beneficially provide a low-mass means of providing structural support for the sheets 102 without reliance on additional spacers to maintain the gap distance D.

In FIG. 9A, the gap-maintaining components 104 include a plurality of solid frames, and each of the sheets 102 is supported by one of the solid frames. In the figure, a single solid frame or gap-maintaining component 104 is shown, with a sheet 102 that is in formed in a tubular configuration being disposed around the frame (for example, via stretching the tubular sheet 102 to fit around the sides or “tension ribs” of the solid frame), such that the frame apply forces F to the tubular sheet 102 in the directions shown by the thick arrows. In some examples, instead of the tubular configuration, two separate sheets 102 may be attached or adhered on the two opposing sides of the frame so as to cover both sides of the frame with the sheets 102. In some examples, more than two sheets may be attached, as suitable.

FIGS. 9B and 9C show a multi-frame DAC assembly or sorbent article assembly 100 which is formed by disposing a plurality of frames or gap-maintaining components 104 side-by-side in a row, where each gap-maintaining component 104 has the sheet 102 (or sheets) applied thereto, in order to form a complete multi-frame structure. The individual frames may be attached, fastened, affixed, or coupled to one another using any suitable means. The top or side surface of the assembly 100 may define a single consolidated surface for reactor interface (that is, an interface for a DAC reactor).

FIGS. 9D and 9E show the configuration of the sheets 102 during adsorption and desorption processes as implemented in the multi-frame structure. Although only three (3) frames are shown, it is to be understood that any suitable number of frames may be implemented, and each frame is to be considered a separate gap-maintaining component 104 which may be removable or replaceable as necessary. As shown in FIG. 9D, each of the frames or gap-maintaining components 104 may include an opening 900 which directs air or gas into and out of an internal volume 902 that is defined by the sheets 102 when supported by the frame or gap-maintaining component 104.

In these examples, the gap distance D is determined not by the sheets 102 but instead by the centerlines (C-C) of the individual frames or gap-maintaining components 104. That is, the gap distance D is the distance between two neighboring centerlines C-C of the adjacent frames or gap-maintaining components 104, such that the gap distance D is maintained even as the sheets 102 move to create a smaller internal volume 902 (a restricted configuration) as shown in FIG. 9D during the adsorption process showing the two sheets (or two portions of the tubular construct) assuming a concave configuration (e.g., a portion thereof flexes inwardly toward the centerline C-C) to conform to the shape of the frame, and as the sheets 102 move to create a larger internal volume 902 (an expanded configuration) as shown in FIG. 9E during the desorption process showing steam, gas, or air flowing into the internal volume 902 through the openings 900 (steam, gas, or air passage) in the frames or gap-maintaining components 104, thereby causing the sheets to assume a convex configuration (e.g., a portion there of flexes outwardly from the centerline C-C).

Such configurations as shown in FIGS. 9A through 9E beneficially provide a modular manifold design using the multi-frame sorbent article assembly 100, where tensioning force F is used to provide structure for the sheets 102. Tensioning force F may reduce the number of spacers necessary to maintain the gap distance D, thereby increasing the effective surface area for adsorption and may allow for thinner sheets 102 to be used for the assembly 100, which may also potentially increase the effective surface area while improving pressure drop during operation.

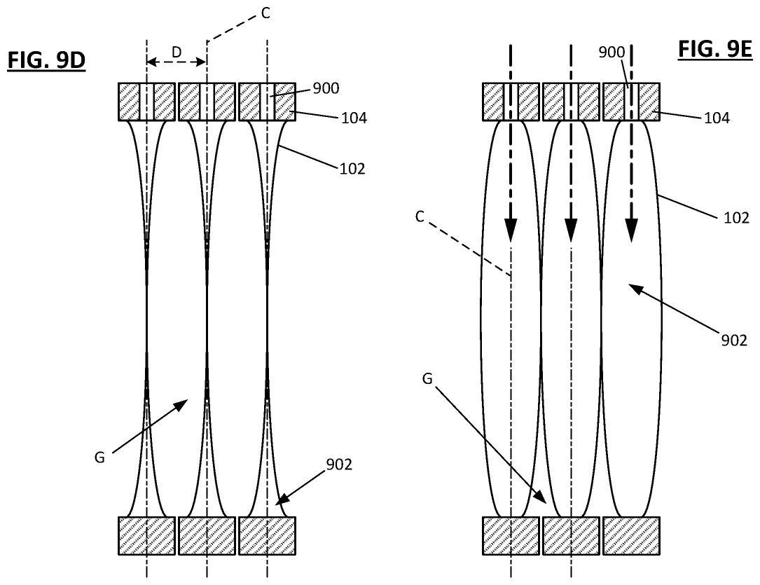

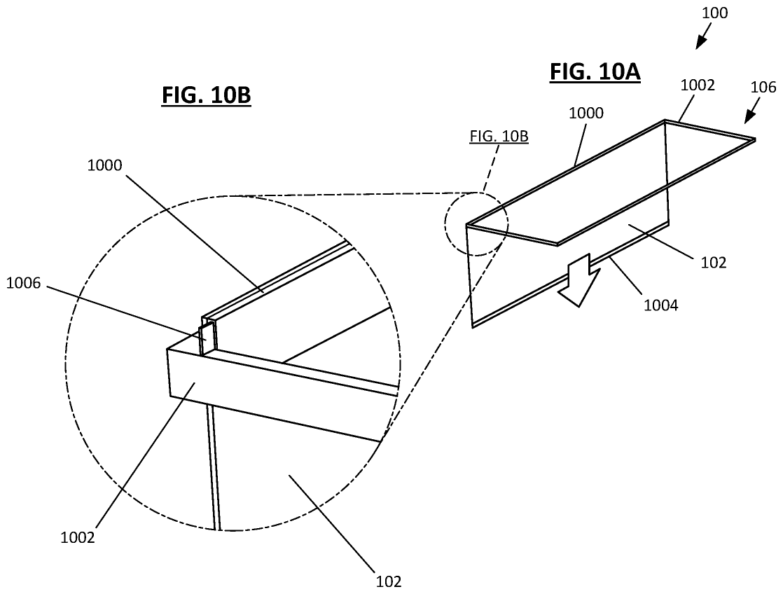

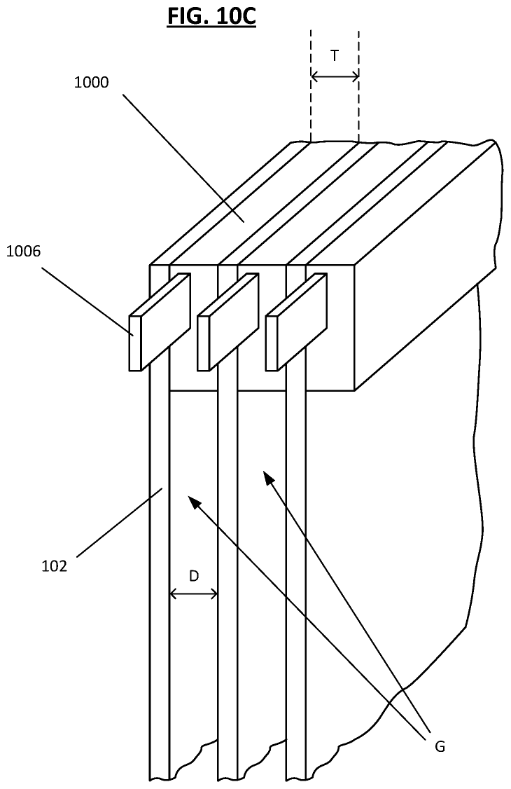

FIGS. 10A through 10C show examples of the sorbent article assembly 100 with a sheet of sorbent material 102 (only one sheet is shown for simplicity, but it is to be understood that there may be a plurality of sheets for each assembly) being suspended vertically from a frame component 1002 of the support framework 106. For example, the sheet of sorbent material 102 has a gap-maintaining component(s) 104, where each gap-maintaining component 104 may include a rigid member 1000 having a predetermined thickness as well as tabs 1006 extending from each side of the rigid member 1000 that rest on and are supported by the frame component 1002 of the support framework 106 to maintain an initial position of the separable sheet 102 hanging from the support framework 106. FIG. 10C shows an example in which multiple sheets of sorbent material 102 are positioned side-by-side, with each sheet having its own separate rigid member 1000. The rigid members 1000 come into contact with each other so as to maintain the gap G between the sheets 102 at a predetermined distance D. The distance D of the gap G may be determined by the thickness “T” of the rigid member 1000.

In some examples, the rigid member 1000 may be attached or adhered to a surface at the top portion of the sheet 102 to maintain the gap G. In some examples, the rigid member 1000 may be coupled with or surround the top portion of the sheet 102. Furthermore, in some examples, the tabs 1006 may have any suitable shape or configuration, including but not limited to: a rectangular shape (which is shown in FIG. 10C), a circular shape, a hooked shape, or a keyed shape, such as those resembling the tabs used in the hanging file folders for a file cabinet. In some examples, the rigid member 1000 and the tabs 1006 may be separate components that are combined or attached together, or the rigid member 1000 and the tabs 1006 may be made of a single unitary material or component. Such configuration includes the benefit of providing tension to the sheets 102 without providing slack, and therefore the free end of the sheets 102 are not impacted by potential tolerance issues, as well as the open end (lower end 102B) of the sheets 102 being able to provide dampened spacing as well as assisting with the drainage of fluid from within the sheets 102.

As shown, a sheet 102 rests on and is hanging from the frame component 1002 as pulled downward by the force F of gravity. In some examples as shown, at least a portion of the sheets 102 may include rigid members 1000, and a frame component 1002 is also provided such that the rigid members 1000, or more specifically the tabs 1006 of the rigid members 1000, are supported by the frame component 1002 of the framework 106. The rigid members 1000 may be attached to the top end 102A of the sheets 102 and the tabs 1006 may extend outwardly by a predetermined length to be supported on both sides by the frame component 1002, which may be substantially rectangular and may act as a railing on which the tabs 1006 may rest. In some examples, the sheets 102 may also include weighted members or portions 1004 attached to or integrated with the sheets 102 at the bottom end 102B. The weighted members or portions 1004 provides additional weight to the sheets 102 to increase the gravitational force or to provide additional gravitational force applied to the sheets 102, thereby causing the sheets 102 to be substantially straight during operation, i.e. the adsorption and desorption processes. In any of the aforementioned examples, during the adsorption and desorption processes, the sheets 102 may be disposed in a substantially horizontal alignment, or alternatively in a substantially vertical alignment, as suitable.

The disclosure of this application has been described above both generically and with regard to specific embodiments. It will be apparent to those skilled in the art that various combination, modifications, and variations can be made in the embodiments without departing from the scope of the disclosure. Thus, it is intended that the embodiments cover the combination, modifications, and variations of this disclosure provided they come within the scope of the appended claims and their equivalents.

### Carbon Dioxide Removal Service Providers

Also disclosed herein are methods for removing gaseous carbon dioxide (CO₂) from the atmosphere using any suitable means, methods, processes, or devices for atmospheric CO₂ removal as disclosed herein. In some examples, a carbon dioxide removal service provider that may be a person, a device, an atmospheric processing facility, a carbon dioxide removal plant, software, an internet site, an electronic interface, an organization, or a corporate agent or entity (that may include a control center, a headquarters, a data management center, an intermediary data collection or processing center, or facilitating organizations that provide information and/or control functions for or services to the provider) or an electronic device or display associated with or accessible to the provider may receive and/or become aware of information about a dispersion of a first quantity of gaseous CO₂ in the atmosphere at a first location. The information may be complete, partial, derivative, or a summary and may be received in the form of an electronic display, an electronic alert, a notification, or other electronic communication (e.g., an email message, a telephone call, or a video call) and may include digital data representing the amount of gaseous CO₂ being dispersed at the first location (e.g., in tons of CO₂) and/or the rate of dispersion (e.g., in tons of CO₂ per minute, hour, day, etc.) as well as the data associated with the first location, such as a name of the city and/or country, GPS location, weather information, etc. In some examples, the information may be in the form of an electronic communication (e.g., first electronic communication) that includes information about the dispersion of the first quantity of gaseous CO₂ into the atmosphere at the first location that may be received from and/or provided to a computing and/or electronic display device.

The carbon dioxide removal service provider may initiate an immediate or subsequent separating of or a method of separating a second quantity of gaseous CO₂ at a second location which may be different from the first location. The second location may be located remote to the first location such as, for example, when the first location is in a populated commercial area and the second location is near a geothermal or other hazardous energy source that powers the separating process at the second location. The second quantity may be at least a portion of the first quantity such as from 0% to 10%, from 10% to 20%, from 20% to 30%, from 30% to 40%, from 40% to 50%, from 50% to 60%, from 60% to 70%, from 70% to 80%, from 80% to 90%, from 90% to 100%, or any other suitable value, combination, or range therebetween. The second quantity may be a portion of the first quantity or the entirety of the first quantity, and the second quantity may be associated with a partial delivery of a carbon removal service involving multiple separating cycles. The separating may include any suitable method or process as disclosed herein or the use of any suitable device as disclosed herein. In some examples, the separating may be initiated by the sending or transmitting of instructions or confirmation to a location that has the capability of performing such separating. In some examples, the separating may be performed by a carbon capture device capable of carrying out any method for separating gaseous CO₂ from a gas mixture in the form of ambient air, as disclosed herein. In some examples, the distance from the first location to the second location may be from 100 km to 200 km, from 200 km to 500 km, from 500 km to 800 km, from 800 km to 1000 km, from 1000 km to 2000 km, from 2000 km to 3000 km, from 3000 km to 4000 km, from 4000 km to 5000 km, from 5000 km to 6000 km, from 6000 km to 7000 km, from 7000 km to 8000 km, from 8000 km to 9000 km, from 9000 km to 10,000 km, from 10,000 km to 15,000 km, from 15,000 km to 20,000 km, or any other suitable value or range therebetween.

The carbon dioxide removal service provider may initiate a reporting of data regarding the second quantity that will be, is being, or has been removed from the atmosphere. The initiating may be initial steps taken to start an immediate or subsequent reporting of data that may be performed via any suitable means of electronic communication or data transmission which may be wired or wireless. In some examples, the reporting may involve the preparing of information to be included in such reporting or later reporting and the subsequent sending or transmitting of instructions or confirmation to another entity or device which has the capability of starting or fully performing such reporting. The reported data may be associated with the carbon capture device as disclosed herein regarding the second quantity. For example, the carbon capture device may generate or provide data associated with the separating of the second quantity of gaseous CO₂, which may be obtained from the carbon capture device directly or indirectly (e.g., via an intermediary entity or device). In examples, at least a part of the data generated by the carbon capture device is provided in an electronic communication. As another example, the data may be summarized or otherwise processed, such that an indication of the data is provided in an electronic communication (e.g., second electronic communication). In some examples, the second electronic communication may be transmitted to the computing or display device. In some examples, the second electronic communication may be transmitted to an additional computing or display device that may be separate or different from the aforementioned computing or display device.

In some examples, the method for removing gaseous CO₂ from the atmosphere may involve a carbon dioxide removal service provider (as described above) that may receive and/or become aware of information about a first quantity of gaseous CO₂ which may include a dispersion of gaseous CO₂. The information may be complete, partial, derivative, or a summary and may be received in the form of an electronic display, an electronic alert, a notification, or other electronic communication (e.g., an email message, a telephone call, or a video call) and may include digital data representing the amount of gaseous CO₂ being dispersed at the first location (e.g., in tons of CO₂) and/or the rate of dispersion (e.g., in tons of CO₂ per minute, hour, day, etc.) as well as the data associated with the first location, such as a name of the city and/or country, GPS location, weather information, etc. Such quantity may represent the amount of gaseous CO₂ being dispersed at a location (e.g., in tons of CO₂) and/or the rate of dispersion (e.g., in tons of CO₂ per minute, hour, day, etc.). In some examples, the information may be received as an electronic communication from another entity or device which sends or transmits instructions concerning gaseous CO₂ removal as disclosed herein. In some examples, an electronic communication (e.g., first electronic communication) that includes information about the dispersion of the first quantity of gaseous CO₂ that may be received from and/or provided to a computing and/or electronic display device.

The carbon dioxide removal service provider may separate or begin separation of a second quantity of gaseous CO₂ from the atmosphere, where the second quantity is at least a portion of the first quantity such as from 0% to 10%, from 10% to 20%, from 20% to 30%, from 30% to 40%, from 40% to 50%, from 50% to 60%, from 60% to 70%, from 70% to 80%, from 80% to 90%, from 90% to 100%, or any other suitable value, combination, or range therebetween. The second quantity may be a portion of the first quantity or the entirety of the first quantity, and the second quantity may be associated with a partial delivery of a carbon removal service involving multiple separating cycles. The separating may include any suitable method or process as disclosed herein or the use of any suitable device as disclosed herein. In some examples, the separating may be performed by a carbon capture device capable of carrying out any method for separating gaseous CO₂ from a gas mixture in the form of ambient air, as disclosed herein.

The carbon dioxide removal service provider may report the data regarding the second quantity that will be, is being, or has been removed from the atmosphere. The reporting of data may be performed via any suitable means of electronic communication or data transmission which may be wired or wireless. In some examples, the reporting may be in response to receiving instructions or confirmation as transmitted from another entity or device which has the capability of starting or fully performing such reporting. The reported data may be associated with the carbon capture device as disclosed herein regarding the second quantity. For example, the carbon capture device may generate or provide data associated with the separating of the second quantity of gaseous CO₂, which may be obtained from the carbon capture device directly or indirectly (e.g., via an intermediary entity or device). In examples, at least a part of the data generated by the carbon capture device is provided in an electronic communication. As another example, the data may be summarized or otherwise processed, such that an indication of the data is provided in an electronic communication (e.g., second electronic communication). In some examples, the second electronic communication may be transmitted to the computing or display device. In some examples, the second electronic communication may be transmitted to an additional computing or display device that may be separate or different from the aforementioned computing or display device.

In some examples, the method for removing gaseous CO₂ from the atmosphere may involve a carbon dioxide removal service provider (as described above) that may transmit, emit, or send out information about a dispersion of a first quantity of gaseous CO₂ into the atmosphere at a first location. The information may be complete, partial, derivative, or a summary and may be received in the form of an electronic display, an electronic alert, a notification, or other electronic communication (e.g., an email message, a telephone call, or a video call) and may include digital data representing the amount of gaseous CO₂ being dispersed at the first location (e.g., in tons of CO₂) and/or the rate of dispersion (e.g., in tons of CO₂ per minute, hour, day, etc.) as well as the data associated with the first location, such as a name of the city and/or country, GPS location, weather information, etc. The transmitting may be an emitting and/or a sending out performed via any suitable means of electronic communication or data transmission which may be wired or wireless that may not be received by the intended recipient or any recipient. In some examples, the information may be in the form of an electronic communication (e.g., first electronic communication) that includes information about the dispersion of the first quantity of gaseous CO₂ into the atmosphere at the first location that may be transmitted, emitted, and/or sent out to a computing device with such transmission, emitting, and/or sending out not necessarily being received by any recipient.

The carbon dioxide removal service provider may request an immediate or subsequent separating of or a method of separating a second quantity of gaseous CO₂ from the atmosphere at a second location. The second location may be located remote to the first location such as, for example, when the first location is in a populated commercial or industrial area and the second location is near a geothermal or other hazardous energy source that powers the separating process at the second location. The second quantity may be at least a portion of the first quantity such as from 0% to 10%, from 10% to 20%, from 20% to 30%, from 30% to 40%, from 40% to 50%, from 50% to 60%, from 60% to 70%, from 70% to 80%, from 80% to 90%, from 90% to 100%, or any other suitable value, combination, or range therebetween. The second quantity may be a portion of the first quantity or the entirety of the first quantity, and the second quantity may be associated with a partial delivery of a carbon removal service involving multiple separating cycles. The separating may include any suitable method or process as disclosed herein or the use of any suitable device as disclosed herein. The requesting of the separating or an initiation of the separating may be performed via any suitable means of electronic communication or data transmission which may be wired or wireless. In some examples, the requesting may be by sending, emitting, or transmitting of instructions to a start command to a location that has the capability of starting or fully performing such separating. In some examples, the separating may be performed by a carbon capture device capable of carrying out any method for separating gaseous CO₂ from a gas mixture in the form of ambient air, as disclosed herein. In some examples, the distance from the first location to the second location may be from 100 km to 200 km, from 200 km to 500 km, from 500 km to 800 km, from 800 km to 1000 km, from 1000 km to 2000 km, from 2000 km to 3000 km, from 3000 km to 4000 km, from 4000 km to 5000 km, from 5000 km to 6000 km, from 6000 km to 7000 km, from 7000 km to 8000 km, from 8000 km to 9000 km, from 9000 km to 10,000 km, from 10,000 km to 15,000 km, from 15,000 km to 20,000 km, or any other suitable value or range therebetween.

The carbon dioxide removal service provider may receive a reporting, an indication of such reporting, and/or an indication of an availability of data regarding the second quantity that will be, is being, or has been removed from the atmosphere. The receiving of the reporting does not require examination or review by a human, may be achieved by simply making the reporting accessible even if subsequently never reviewed or acknowledged, and/or may be performed via any suitable means of electronic communication or data transmission which may be wired or wireless. In some examples, the receiving of the reporting may regard the second quantity, such as how much of the gaseous CO₂ was separated within a predetermined amount of time, for example within a day, a week, a month, etc. The reported data may be associated with the carbon capture device as disclosed herein regarding the second quantity. For example, the carbon capture device may generate or provide data associated with the separating of the second quantity of gaseous CO₂, which may be obtained from the carbon capture device directly or indirectly (e.g., via an intermediary entity or device). In examples, at least a part of the data generated by the carbon capture device is provided in an electronic communication. As another example, the data may be summarized or otherwise processed, such that an indication of the data is provided in an electronic communication (e.g., second electronic communication). In some examples, the second electronic communication is received from the computing device. In some examples, the second electronic communication is received in response to the transmitting of the first electronic communication. In some examples, the second electronic communication is received from the computing or display device in response to the transmitting of the first electronic communication to the computing or display device.

As used herein, “receiving” information is to be understood as an act of “receiving” which requires only one party (or entity, device, etc.) to perform, such that a separate party for performing the act of “sending” is not required.

As used herein, “initiating” a separating (or a method of separating) is to be understood as an act of “initiating” that includes an initial or completed act of preparing or dispatching instructions to another party or device with the intent that there is an execution or start of a separating process or the association of an already started separating process with the initiating step. For example, the act of “initiating” the separating of gaseous CO₂ may cause a carbon capture device to subsequently receive an instruction, either directly or indirectly (e.g., via intermediary entities or devices) to initiate the separating, in response to which the carbon capture device operates accordingly. In another example, the act of “initiating” a separating (or a method of separating) gaseous CO₂ may include a carbon dioxide removal service provider associating carbon dioxide that has already been removed from the atmosphere (or presently in an active removal process) with a subsequent initiating of a separating. It will be appreciated that the instruction received by the carbon capture device need not be provided as part of such an “initiating” operation. Further, the act of “separating” of the CO₂, for example, is therefore not necessarily part of the act of “initiating” such separating, such as when the “initiating” of the separating is performed by a first party and the subsequent “separating” itself is performed by a second party different from the first party. Furthermore, the act of “separating” does not need to be accomplished or fully completed, either by the first party or the second party. It will also be appreciated that the act of initiating can be fully performed in one jurisdiction or country even though an acknowledgement of the initiating or an act subsequent to or associated with the initiating takes place in a different jurisdiction or country.

As used herein, “initiating” a reporting (e.g., of data) is to be understood as an act of “initiating” that includes the initial or complete act of preparing or dispatching instructions to another party to prepare, start, or complete the reporting at a later time. The act of “reporting” any data, for example, is therefore not necessarily part of the act of “initiating” such reporting, such as when the “initiating” of the reporting is performed by a first party (the initiating party) and the “reporting” itself is performed by a second party (the reporting party) different from the first party (the initiating party). Furthermore, the act of “reporting” does not need to be accomplished or fully completed, either by the first party or the second party. It will be appreciated that the act of initiating can be fully performed in one jurisdiction or country even though an acknowledgement of the initiating or an act subsequent to or associated with the initiating takes place in a different jurisdiction or country.

As used herein, “reporting” data is to be understood as an act of “reporting” which may require only one party (reporting party) to perform. Furthermore, the act of “reporting” does not require the receipt (or confirmation of receipt) of such reporting by another party (receiving party). The reporting may be a storage of the data or display of the data at a location that is accessible to an intended recipient, and may still be considered to be a reporting even when the intended recipient does not access or review the data.

As used herein, “transmitting” information is to be understood as an act of “transmitting” which may require only one party (the transmitting party) to perform. Furthermore, the act of “transmitting” does not require a receiver (e.g., receiving party) or receipt (e.g., confirmation of receipt) of the information that is transmitted.

As used herein, “requesting” a separating (or initiation of a method of separating) is to be understood as an act of “requesting” which may require only one party (the requesting party) to perform. Also, the act of “separating” which is requested by the act of “requesting” may be performed by another party (the separating party). Furthermore, the act of “requesting” may be only intended or started and does not need to be accomplished or fully completed (e.g., when no separating results from the act of “requesting” such separating). In an example, the act of “requesting” a separating (or initiation of a method of separating) of gaseous CO₂ may include a carbon dioxide removal service provider associating carbon dioxide that has already been removed from the atmosphere (or presently in an active removal process) with a subsequent request for a separating. It will be appreciated that the act of requesting can be fully performed in one jurisdiction or country even though an acknowledgement of the requesting or an act subsequent to or associated with the requesting takes place in a different jurisdiction or country.

As used herein, “receiving” a reporting or an indication of the reporting is to be understood as an act of “receiving” which does not require a sender (e.g., sending party). The receiving may be a storage of the data or display of the data at a location that is accessible to an intended recipient, and may still be considered to be a receiving even when the intended recipient does not access or review the data.

As can be appreciated, the first quantity, the second quantity, and the portion of the first quantity may be estimated or projected values. It can be further appreciated that carbon dioxide gas released or dispersed at the first location may not necessarily include or be the same CO₂ molecules separated or collected at the second location, and that the second quality may be an equivalent quantity of CO₂ that was released or dispersed. The CO₂ in the portion of the first quantity may be in a non-gaseous form. The portion of the first quantity or the second quantity may refer to carbon dioxide that is entrapped in the sorbent as disclosed herein or that has been stored or otherwise converted into another form. The portion of the first quantity or the second quantity may also include gases other than carbon dioxide. For example, the second quantity may be in a non-gaseous form or combined with other materials.

As used herein, a “carbon capture device” refers to any one or more devices as disclosed herein that is capable of separating gaseous CO₂ from the atmosphere at the location at which the device is installed or located. The carbon capture device may refer to a single device or a plurality of devices, or a facility containing therein one or more such devices or component devices that act in concert. The device may include, for example, the desorbing media source(s) and the adsorber structure(s) as disclosed herein. The device may be operable by a user or operator using an electronic device. The device may generate data associated with its operation, for example as may be detected by one or more sensors and/or as may include log data, among other examples.

As used herein, an “electronic device” is capable of performing one or more electronic operations, for example a computer, smartphone, smart tablet, etc. The electronic device may include for example a display device and/or one or more processing units and one or more memory units. The processing unit may include a central processing unit (CPU), a microprocessor, system on a chip (SoC), or any other processor capable of performing such operations. The memory unit may by a non-transitory computer-readable storage medium storing one or more programs or instructions thereon which, when run on the processing unit, causes the processing unit or the electronic device to perform one or more methods as disclosed herein. The memory unit may include one or more memory chips capable of storing data and allowing storage location to be accessed by the processing unit(s), for example a volatile or non-volatile memory, static or dynamic random-access memory, or any variant thereof. In some examples, the electronic device may be referred to as a computing device.

Technical advantages of removing gaseous CO₂ from an atmosphere using the methods or processes as disclosed herein includes, but are not limited to, facilitating a network of entities and/or devices that are capable of communicating with other entities and/or devices in order to remotely provide instructions or facilitating separation and removal of gaseous CO₂ without requiring to be physically at the location to do so. Furthermore, the methods and processes as disclosed herein provide a robust network of interinstitutional communication such that each entity (which may be an institution associated with a physical location) is capable of directing or initiating the separation and removal of gaseous CO₂ at multiple locations simultaneously, as well as having the capability of flexibly changing the location at which separation and removal of gaseous CO₂ is determined to be removed. The change in location may be performed at or near real-time such that there is minimal time lag between when the instructions are provided and when the separating of gaseous CO₂ takes place at the designated location, for example. In some examples, the methods or processes as disclosed herein provides a flexible communication network in which the entity or device which performs the separation and removal of gaseous CO₂ at the designated location may provide a timely reporting (e.g., operation summary and/or invoice for the service rendered) associated with the amount of gaseous CO₂ that was removed during a predetermined time period. Such reporting may be generated automatically or manually, may be generated at a predetermined time interval (e.g., once every day, week, month, etc.) or more flexibly as manually determined (e.g., each time a user or entity requests), or may be generated in response to achieving or exceeding a predetermined threshold, including but not limited to the amount of gaseous CO₂ that was separated and removed from the atmosphere (e.g., every 1 ton, 5 tons, 10 tons, etc., of gaseous CO₂ that was removed from the atmosphere), and any other suitable conditions as determined and agreed upon by the entities involved, for example.

Various modifications and additions can be made to the exemplary embodiments discussed without departing from the scope of the present disclosure. For example, while the embodiments described above refer to particular features, the scope of this disclosure also includes embodiments having different combinations of features and embodiments that do not include all of the described features. Accordingly, the scope of the present disclosure is intended to embrace all such alternatives, modifications, and variations as fall within the scope of the claims, together with all equivalents thereof.

1. A carbon dioxide sorbent article assembly comprising:
separable sheets of sorbent article disposed adjacent to each other to define a gap between adjacent separable sheets, the gap being maintained uniformly between opposing surfaces of adjacent separable sheets to define a passage extending between adjacent separable sheets from an inlet of the separable sheets to an outlet of the separable sheets; and
a support framework supporting the separable sheets to maintain the gap, the support framework having a gap-maintaining component extending from the support framework along at least one separable sheet to maintain an initial position of the separable sheet.

2. The carbon dioxide sorbent article assembly of claim 1, wherein the gap-maintaining component or the separable sheets are under tension to maintain the initial position.

3. The carbon dioxide sorbent article assembly of claim 1, wherein each of the separable sheets includes a shortened-length portion and the gap-maintaining component is an elastomer component disposed on the separable sheets at the shortened-length portion.

4. The carbon dioxide sorbent article assembly of claim 3, wherein the shortened-length portion is formed via corrugation or crumpling of a portion of the separable sheet.

5. The carbon dioxide sorbent article assembly of claim 3, wherein the shortened-length portion of the each of the separable sheets assumes one of a shortened configuration and an elongated configuration.

6. The carbon dioxide sorbent article assembly of claim 5, wherein the separable sheets change between the shortened configuration and the elongated configuration in response to swelling or shrinkage of a material forming the separable sheets.

7. The carbon dioxide sorbent article assembly of claim 1, wherein the gap-maintaining component comprises a plurality of elongated members attached to the support framework in a taut configuration such that the elongated members provide support for the separable sheets.

8. The carbon dioxide sorbent article assembly of claim 7, wherein the elongated members form a crisscross pattern such that each of the separable sheets are disposed between two neighboring elongated members.

9. The carbon dioxide sorbent article assembly of claim 7, wherein each of the elongated members comprises at least one of: a wire, a fiber, or a filament.

10. A carbon dioxide sorbent article assembly comprising:
separable sheets of sorbent article disposed adjacent to each other to define a gap between adjacent separable sheets, the gap being maintained uniformly between opposing surfaces of adjacent separable sheets to define a passage extending between adjacent separable sheets from an inlet of the separable sheets to an outlet of the separable sheets; and
a support framework supporting the separable sheets to maintain the gap, the support framework having gap-maintaining components extending from the support framework through an internal portion of each of the separable sheets to maintain an initial position of each of the separable sheets.

11. The carbon dioxide sorbent article assembly of claim 10, wherein the gap-maintaining component comprises a plurality of substantially planar structural members attached to the support framework in order to maintain the separable sheets in a taut configuration.

12. The carbon dioxide sorbent article assembly of claim 11, wherein each of the structural members includes a first surface and a second surface, and at least one of the first or second surface comprises one of the separable sheets attached thereto.

13. The carbon dioxide sorbent article assembly of claim 12, wherein the separable sheets are attached to both the first surface and the second surface of the structural member such that the structural member is disposed between two of the separable sheets.

14. The carbon dioxide sorbent article assembly of claim 13, wherein the structural members are at least one of: films, filaments, metallic or polymeric sheets, metallic, polymeric meshes, or fabrics.

15. The carbon dioxide sorbent article assembly of claim 10, wherein the gap-maintaining component is an elongated member with a plurality of enlarged members attached thereto, such that the elongated member punctures through each of the separable sheets, and each of the enlarged members is attached to one of the separable sheets.

16. The carbon dioxide sorbent article assembly of claim 15, wherein the enlarged members are self-expanding plugs.

17. The carbon dioxide sorbent article assembly of claim 15, further comprising a plurality of sealing members that seal openings formed by the elongated member puncturing through the separable sheets.

18. The carbon dioxide sorbent article assembly of claim 10, wherein the gap-maintaining component is an elongated member, and the separable sheets have a plurality of self-sealing locations to maintain sheet integrity where the separable sheets engage the elongated member.

19. The carbon dioxide sorbent article assembly of claim 18, wherein the self-sealing locations include a plurality of polymeric components disposed on a surface of the separable sheets to attach the elongated member to the separable sheets.

20. The carbon dioxide sorbent article assembly of claim 10, wherein the gap-maintaining component is an elongated member having a plurality of enlarged portions and puncturing through each of the separable sheets, the carbon dioxide sorbent article assembly further comprising a plurality of sealing members attached to the separable sheets and seals openings formed by the elongated member puncturing through the separable sheets.

21. The carbon dioxide sorbent article assembly of claim 20, wherein the sealing members are formed as a plurality of hardened adhesive dots extending through the separable sheets, wherein the hardened adhesive dots have a portion extending outwardly from a surface of the separable sheet.

22. The carbon dioxide sorbent article assembly of claim 21, wherein one or more of the hardened adhesive dots includes a through-hole therein to allow passage of the elongated member therethrough and prevent passage of the plurality of enlarged portions therethrough.

23. The carbon dioxide sorbent article assembly of claim 10, wherein the gap-maintaining component is a filament with a plurality of stitched portions, such that each of the stitched portions attaches the filament to one of the separable sheets.

24. The carbon dioxide sorbent article assembly of claim 10, wherein the gap-maintaining component comprises a plurality of solid frames, and each of the separable sheets is supported by one of the solid frames.

25. The carbon dioxide sorbent article assembly of claim 24, wherein the separable sheets are formed in tubular configuration and disposed around the solid frames.

26. The carbon dioxide sorbent article assembly of claim 24, wherein the predetermined distance is defined by a distance between two centerlines of a neighboring pair of solid frames in the solid frames.

27. The carbon dioxide sorbent article assembly of claim 26, wherein the each of the separable sheets defines an internal volume when supported by the one of the solid frames, wherein the internal volume assumes a restricted configuration during the adsorption process and an expanded configuration during the desorption process.

28. The carbon dioxide sorbent article assembly of claim 27, wherein the each of the separable sheets includes one or more openings coupled with the internal volume and facilitates passage of air or steam therethrough.

29. A carbon dioxide sorbent article assembly comprising:
separable sheets of sorbent article disposed adjacent to each other to define a gap between adjacent separable sheets, the gap being maintained uniformly between opposing surfaces of adjacent separable sheets to define a passage extending between adjacent separable sheets from an inlet of the separable sheets to an outlet of the separable sheets; and
a support framework supporting the separable sheets to maintain the gap, the support framework having gap-maintaining components extending from the support framework through adjacent separable sheets to maintain an initial position of each of the separable sheets, the gap-maintaining components having internal portions passing through the adjacent separable sheets and gap portions disposed between the adjacent separable sheets.

30. The carbon dioxide sorbent article assembly of claim 29, wherein the gap-maintaining component comprises a plurality of fibers threaded through the separable sheets in a predetermined threading pattern.

31. The carbon dioxide sorbent article assembly of claim 30, wherein ends of the separable sheets are in contact with or coupled to an inner surface of the support framework.

32. The carbon dioxide sorbent article assembly of claim 30, further comprising an adhesive or fastener attachable to the separable sheets to the support framework.

33. The carbon dioxide sorbent article assembly of claim 32, wherein the adhesive or fastener is attached to a portion of the separable sheets.

34. The carbon dioxide sorbent article assembly of claim 30, wherein the fibers comprise a first set of fibers and a second set of fibers, wherein the first set of fibers is threaded in a first threading pattern, and the second set of fibers is threaded in a second threading pattern symmetrical to the first threading pattern.

35. A carbon dioxide sorbent article assembly comprising:
separable sheets of sorbent article disposed adjacent to each other to define a gap between adjacent separable sheets, the gap being maintained uniformly between opposing surfaces of adjacent separable sheets to define a passage extending between adjacent separable sheets from an inlet of the separable sheets to an outlet of the separable sheets; and
a support framework supporting the separable sheets to maintain the gap, each of the separable sheets having a gap-maintaining component extending from the separate sheet to rest on the support framework and to maintain an initial position of the separable sheet hanging from the support framework.

36. The carbon dioxide sorbent article assembly of claim 35, wherein the separable sheets are suspended vertically from the support framework.

37. The carbon dioxide sorbent article assembly of claim 36, wherein the gap-maintaining component includes a rigid member having a thickness and tabs extending therefrom that rest on and are supported by a frame component of the support framework.

38. The carbon dioxide sorbent article assembly of claim 37, wherein each of the separable sheets includes a weighted portion applying additional gravitational force on the separable sheet.
